(19) United States
(12) Patent Application Publication
(10) Pub. No.: US 2024/0381211 A1
(43) Pub. Date: Nov. 14, 2024

(54) ELECTRONIC DEVICE AND METHOD FOR PERFORMING HANDOVER, AND COMPUTER-READABLE STORAGE MEDIUM

(71) Applicant: SAMSUNG ELECTRONICS CO., LTD., Suwon-si (KR)

(72) Inventors: Junsuk KIM, Suwon-si (KR); Jinwoo KIM, Suwon-si (KR); Minho YANG, Suwon-si (KR); Hyoungjoo LEE, Suwon-si (KR); Taeyoon KIM, Suwon-si (KR); Junyoung WOO, Suwon-si (KR); Euichang JUNG, Suwon-si (KR); Chaiman LIM, Suwon-si (KR)

(21) Appl. No.: 18/652,471

(22) Filed: May 1, 2024

Related U.S. Application Data
(63) Continuation of application No. PCT/KR2022/013262, filed on Sep. 5, 2022.

(30) Foreign Application Priority Data
Nov. 3, 2021 (KR) 10-2021-0149835
Nov. 26, 2021 (KR) 10-2021-0165350

(51) Int. Cl. H04W 36/30; H04B 17/318; H04B 17/382; H04W 36/00; H04W 36/08

(52) U.S. Cl. CPC H04W 36/305; H04W 36/0072; H04W 36/085; H04W 36/304; H04B 17/318; H04B 17/382

(57) ABSTRACT

An electronic device may include: a plurality of antenna modules; a communication circuit connected to the plurality of antenna modules; and at least one processor configured to: receive a first message from a first base station, which is a serving base station of the electronic device; identify, from among the plurality of antenna modules, a first antenna module for forming a first reception beam; identify, from among the plurality of antenna modules, a second antenna module for forming a second reception beam; and perform handover from the first base station to a second base station on the basis of transmitting a second message including first information for indicating the quality of at least one first signal through the first reception beam and second information for indicating the quality of at least one second signal through the second reception beam.

### CROSS-REFERENCE TO RELATED APPLICATIONS

This application is a continuation application of International Application No. PCT/KR2022/013262 filed on Sep. 5, 2022, in the Korean Intellectual Property Receiving Office, and claiming priority to Korean Patent Application No. 10-2021-0149835 filed on Nov. 3, 2021; and Korean Patent Application No. 10-2021-0165350 filed on Nov. 26, 2021, in the Korean Intellectual Property Office; the disclosures of which are all hereby incorporated by reference herein in their entireties.

### BACKGROUND

### Field

Certain example embodiments relate to an electronic device, a method, and/or a computer-readable storage medium for performing a handover.

### Description of Related Art

In new radio (NR), according to a frequency band used in mobile communication, it can be divided into a frequency range (FR) 1 band in Sub-6 GHz band and a FR 2 band in Above-6 GHz band. A signal in the FR 2 band based on the mmWave band may have a poor propagation characteristic because it has greater straightness compared to the Sub-6 GHz frequency band previously used in mobile communication. Therefore, in the FR 2 band, a beamforming technology capable of focusing antenna gains in a specific direction may be used to compensate for radio wave loss.

### SUMMARY

In the FR 2 band, in order to perform a DAPS handover, an electronic device may have to form two receiving beams using the same antenna module. When two receiving beams are formed using the same antenna module, signals may not be simultaneously received from the first base station and the second base station. Therefore, a method for controlling the DAPS handover may be required.

The technical problems to be achieved in this document are not limited to those described above, and other technical problems not mentioned herein will be clearly understood by those having ordinary knowledge in the art to which the present disclosure belongs, from the following description.

According to various example embodiments, an electronic device may comprise a plurality of antenna modules each comprising at least one antenna, a communication circuit connected, directly or indirectly, to the plurality of antenna modules, and at least one processor, comprising processing circuitry, operably coupled with the communication circuit. The at least one processor may be individually and/or collectively configured to receive a first message from a first base station which is a serving base station of the electronic device. The at least one processor may be configured to, after receiving the first message, identify a first antenna module for forming a first receiving beam identified based on at least one first signal received from the first base station, among the plurality of antenna modules. The at least one processor may be configured to, after receiving the first message, identify a second antenna module for forming a second receiving beam identified based on at least one second signal received from a second base station which is a neighbor base station of the first base station, among the plurality of antenna modules. The at least one processor may be configured to perform handover from the first station to the second station, based on transmitting a second message comprising first information for indicating quality of the at least one first signal received from the first base station through the first receiving beam, and second information for indicating quality of the at least one second signal received from the second base station through the second receiving beam.

According to various example embodiments, a method of an electronic device may comprise receiving a first message from a first base station which is a serving base station of the electronic device, and after receiving the first message, identifying a first antenna module for forming a first receiving beam identified based on at least one first signal received from the first base station, among a plurality of antenna modules. The method may comprise, after receiving the first message, identifying a second antenna module for forming a second receiving beam identified based on at least one second signal received from a second base station which is a neighbor base station of the first base station, among the plurality of antenna modules. The method may comprise, based on transmitting a second message comprising first information for indicating quality of the at least one first signal received from the first base station through the first receiving beam, and second information for indicating quality of the at least one second signal received from the second base station through the second receiving beam, performing handover from the first station to the second station.

According to various example embodiments, a non-transitory computer readable storage medium may store one or more programs. The one or more programs may comprise instructions which, when executed by a processor of an electronic device with a plurality of antenna modules and a communication circuit, cause the electronic device to receive a first message from a first base station which is a serving base station of the electronic device. The one or more programs may comprise instructions which, when executed by the processor, cause the electronic device to, after receiving the first message, identify a first antenna module for forming a first receiving beam identified based on at least one first signal received from the first base station, among a plurality of antenna modules. The one or more programs may comprise instructions which, when executed by the processor, cause the electronic device to, after receiving the first message, identify a second antenna module for forming a second receiving beam identified based on at least one second signal received from a second base station which is a neighbor base station of the first base station, among the plurality of antenna modules. The one or more programs may comprise instructions which, when executed by the processor, cause the electronic device to perform handover from the first station to the second station, based on transmitting a second message comprising first information for indicating quality of the at least one first signal received from the first base station through the first receiving beam, and second information for indicating quality of the at least one second signal received from the second base station through the second receiving beam.

In certain example embodiments, an electronic device can control a DAPS handover operation set by a base station in a FR 2 band. According to an available state of an antenna module and a receiving beam of the electronic device, the electronic device can control the DAPS handover operation, by controlling the receiving beam.

The effects that can be obtained from the present disclosure are not limited to those described above, and any other effects not mentioned herein will be clearly understood by those having ordinary knowledge in the art to which the present disclosure belongs, from the following description.

### BRIEF DESCRIPTION OF THE DRAWINGS

FIG. 1 is a block diagram of an electronic device in a network environment according to various example embodiments.

FIG. 2 is a block diagram of an electronic device for supporting legacy network communication and 5G network communication according to various example embodiments.

FIG. 3 illustrates an example of an operation for a wireless communication connection between a base station and an electronic device, in a second network of FIG. 2 using a directional beam for a wireless connection.

FIG. 4 is a block diagram of an electronic device for 5G network communication according to an example embodiment.

FIGS. 5A to 5C illustrate an example in which a handover is performed in an electronic device.

FIG. 6 is a simplified block diagram of an electronic device according to various example embodiments.

FIG. 7 illustrates an example in which a DAPS handover is performed, according to various example embodiments.

FIG. 8 is a flowchart illustrating an operation of an electronic device according to various example embodiments.

FIGS. 9A to 9B illustrate an example of an operation of an electronic device according to various example embodiments.

FIG. 10 illustrates another example of an operation of an electronic device according to various example embodiments.

FIG. 11 illustrates another example of an operation of an electronic device according to various example embodiments.

FIG. 12 illustrates another example of an operation of an electronic device according to various embodiments.

FIG. 13 illustrates another example of an operation of an electronic device according to various example embodiments.

FIG. 14 is a flowchart illustrating another operation of an electronic device according to various example embodiments.

### DETAILED DESCRIPTION

Hereinafter, various embodiments of the present document will be described with reference to the accompanying drawings.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and docs not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

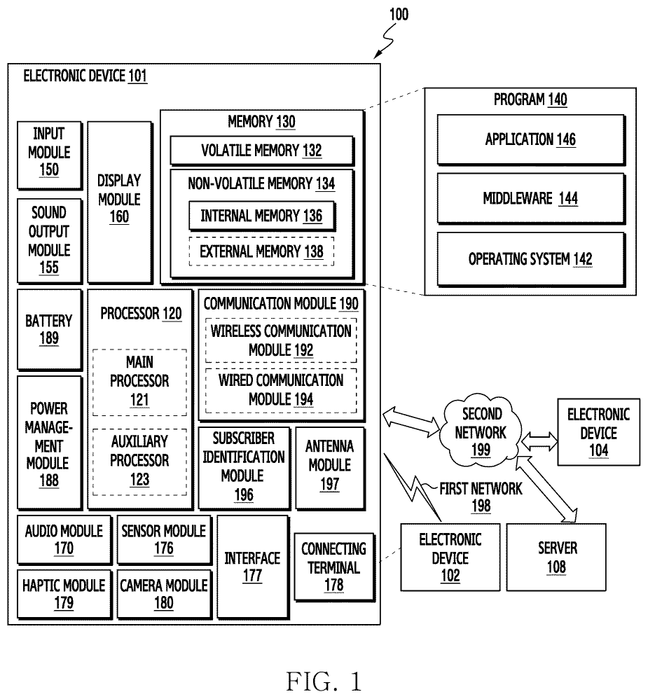

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor(s) 120 comprising processing circuitry, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function.

The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoclectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

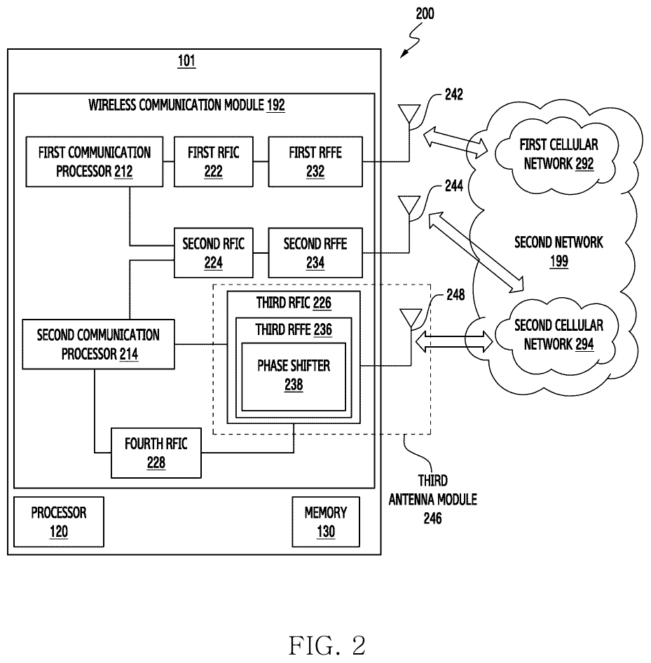

FIG. 2 is a block diagram 200 of the electronic device 101 for supporting legacy network communication and 5G network communication, according to various embodiments. Referring to FIG. 2, the electronic device 101 may include a first communication processor 212, a second communication processor 214, a first radio frequency integrated circuit (RFIC) 222, a second RFIC 224, and a third RFIC 226, a fourth RFIC 228, a first radio frequency front end (RFFE) 232, a second RFFE 234, a first antenna module 242, a second antenna module 244, and an antenna 248. The electronic device 101 may further include the processor 120 and the memory 130. The second network 199 may include a first cellular network 292 and a second cellular network 294. According to another embodiment, the electronic device 101 may further include at least one of the components illustrated in FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may constitute at least a part of a wireless communication module 192. According to another embodiment, the fourth RFIC 228 may be omitted or may be included as a part of the third RFIC 226. Each processor herein comprises processing circuitry.

The first communication processor 212 may support the establishment of a communication channel of a band to be used for wireless communication with the first cellular network 292 and legacy network communication through the established communication channel. According to various embodiments, the first cellular network 292 may be a legacy network including a 2nd generation (2G), 3rd generation (3G), 4th generation (4G), and/or long-term evolution (LTE) network. The second communication processor 214 may support the establishment of a communication channel corresponding to a specified band (e.g., approximately 6 GHz to 60 GHZ) among bands to be used for wireless communication with the second cellular network 294, and 5G network communication through the established communication channel. According to various embodiments, the second cellular network 294 may be a 5G network defined by 3GPP. Additionally, according to an embodiment, the first communication processor 212 or the second communication processor 214 may support the establishment of a communication channel corresponding to another specified band (e.g., approximately 6 GHz or less) among bands to be used for wireless communication with the second cellular network 294, and 5G network communication through the established communication channel. According to an embodiment, the first communication processor 212 and the second communication processor 214 may be implemented in a single chip or a single package. According to various embodiments, the first communication processor 212 or the second communication processor 214 may be formed with the processor 120, the coprocessor 123 of FIG. 1, or the communication module 190 in a single chip or a single package.

Upon transmission, the first RFIC 222 may convert a baseband signal generated by the first communication processor 212 into a radio frequency (RF) signal of approximately 700 MHZ to approximately 3 GHz used in the first cellular network 292 (e.g., a legacy network). Upon reception, an RF signal may be obtained from the first cellular network 292 (e.g., a legacy network) through an antenna (e.g., the first antenna module 242), and may be preprocessed through an RFFE (e.g., the first RFFE 232). The first RFIC 222 may convert the preprocessed RF signal into a baseband signal so as to be processed by the first communication processor 212.

Upon transmission, the second RFIC 224 may convert a baseband signal generated by the first communication processor 212 or the second communication processor 214 into an RF signal (hereinafter, referred to as a 5G Sub6 RF signal) of the Sub6 band (e.g., approximately 6 GHz or less) used in the second cellular network 294 (e.g., the 5G network). Upon reception, a 5G Sub6 RF signal may be obtained from the second cellular network 294 (e.g., the 5G network) through an antenna (e.g., the second antenna module 244), and may be preprocessed through an RFFE (e.g., the second RFFE 234). The second RFIC 224 may convert the preprocessed 5G Sub6 RF signal into a baseband signal so as to be processed by a corresponding one of the first communication processor 212 or the second communication processor 214.

The third RFIC 226 may convert a baseband signal generated by the second communication processor 214 into an RF signal (hereinafter, referred to as a 5G Above6 RF signal) of the 5G Above6 band (e.g., approximately 6 GHz to approximately 60 GHZ) to be used in the second cellular network 294 (e.g., the 5G network). Upon reception, a 5G Above6 RF signal may be obtained from the second cellular network 294 (e.g., the 5G network) through an antenna (e.g., the antenna 248), and may be preprocessed through the third RFFE 236. For example, the third RFFE 236 may perform preprocessing of the signal by using a phase shifter 238. The third RFIC 226 may convert the preprocessed 5G Above6 RF signal into a baseband signal so as to be processed by the second communication processor 214. According to an embodiment, the third RFFE 236 may be formed as a part of the third RFIC 226.

According to an embodiment, the electronic device 101 may include the fourth RFIC 228 separately from or at least as a part of the third RFIC 226. In this case, the fourth RFIC 228 may convert the baseband signal generated by the second communication processor 214 into an RF signal (hereinafter, referred to as an intermediate frequency (IF) signal) of an intermediate frequency band (e.g., approximately 9 GHz to approximately 11 GHZ), and then transmit the IF signal to the third RFIC 226. The third RFIC 226 may convert the IF signal into a 5G Above6 RF signal. Upon reception, a 5G Above6 RF signal may be received from the second cellular network 294 (e.g., the 5G network) through an antenna (e.g., the antenna 248), and may be converted into an IF signal by the third RFIC 226. The fourth RFIC 228 may convert the IF signal into the baseband signal so as to be processed by the second communication processor 214.

According to an embodiment, the first RFIC 222 and the second RFIC 224 may be implemented as a single chip or at least a part of a single package. According to an embodiment, the first RFFE 232 and the second RFFE 234 may be implemented as a single chip or at least a part of a single package. According to an embodiment, at least one of the first antenna module 242 or the second antenna module 244 may be omitted or combined with another antenna module to process RF signals of a plurality of corresponding bands.

According to an embodiment, the third RFIC 226 and the antenna 248 may be disposed on the same substrate to form a third antenna module 246. For example, the wireless communication module 192 or the processor 120 may be disposed on a first substrate (e.g., a main PCB). In this case, the third RFIC 226 may be disposed in a partial region (e.g., the lower surface) of a second substrate (e.g., a sub PCB) separate from the first substrate, and the antenna 248 may be disposed in another partial region (e.g., the upper surface) to form the third antenna module 246. According to an embodiment, the antenna 248 may include, for example, an antenna array that may be used for beamforming. By disposing the third RFIC 226 and the antenna 248 on the same substrate, it is possible to reduce the length of the transmission line therebetween. This, for example, may reduce the loss (e.g., attenuation) of a signal in a high frequency band (e.g., approximately 6 GHz to approximately 60 GHZ) used for 5G network communication by the transmission line. Accordingly, the electronic device 101 may improve the quality or speed of communication with the second cellular network 294 (e.g., the 5G network).

The second cellular network 294 (e.g., the 5G network) may be operated independently of (e.g., Stand-Alone (SA)) or operated to be connected to (e.g., Non-Stand Alone (NSA)) the first cellular network 292 (e.g., the legacy network). For example, in the 5G network, there may be only an access network (e.g., 5G radio access network (RAN) or next-generation RAN (NG RAN)) and no core network (e.g., next-generation core (NGC)). In this case, after accessing the access network of the 5G network, the electronic device 101 may access an external network (e.g., the Internet) under the control of a core network (e.g., evolved packed core (EPC)) of the legacy network. Protocol information for communication with the legacy network (e.g., LTE protocol information) or protocol information for communication with the 5G network (e.g., New Radio (NR) protocol information) may be stored in the memory 230 and may be accessed by other components (e.g., the processor 120, the first communication processor 212, or the second communication processor 214).

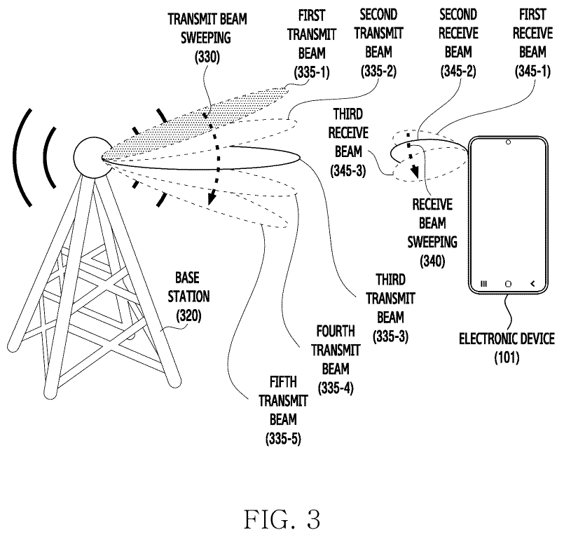

FIG. 3 illustrates an embodiment of an operation for wireless communication connection between a base station 320 and the electronic device 101 by using a directional beam for wireless connection in the second network 294 (e.g., the 5G network) of FIG. 2. First, the base station (gNodeB (gNB), transmission reception point (TRP)) 320 may perform a beam detection operation with the electronic device 101 for wireless communication connection. In the illustrated embodiment, for beam detection, the base station 320 may sequentially transmit a plurality of transmit beams, for example, first to fifth transmit beams 331-1 to 331-5 having different directions, thereby making it possible to perform at least one transmit beam sweeping 330.

The first to fifth transmit beams 331-1 to 331-5 may include at least one synchronization sequences (SS)/physical broadcast channel (PBCH) block (SS/PBCH Block). The SS/PBCH Block may be used to periodically measure a channel or beam strength of the electronic device 101.

In another embodiment, the first to fifth transmit beams 331-1 to 331-5 may include at least one channel state information-reference signal (CSI-RS). The CSI-RS is a reference signal that the base station 320 may set flexibly and may be transmitted periodically, semi-persistently or aperiodically. The electronic device 101 may measure a channel or beam strength by using the CSI-RS.

The transmit beams may form a radiation pattern having a selected beam width. For example, the transmit beams may have a broad radiation pattern having a first beam width or a sharp radiation pattern having a second beam width shaper than the first beam width. For example, transmit beams including SS/PBCH block may have a broader radiation pattern than transmit beams including CSI-RS.

The electronic device 101 may perform receive beam sweeping 340 while the base station 320 performs the transmit beam sweeping 330. For example, while the base station 320 performs first transmit beam sweeping 330, the electronic device 101 may fix a first receive beam 345-1 in a first direction to receive a signal of an SS/PBCH block transmitted in at least one of the first to fifth transmit beams 331-1 to 331-5. While the base station 320 performs second transmit beam sweeping 330, the electronic device 101 may fix a second receive beam 345-2 in a second direction to receive a signal of an SS/PBCH block transmitted in the first to fifth transmit beams 331-1 to 331-5. In this way, the electronic device 101 may select a communicable receive beam (e.g., the second receive beam 345-2) and a communicable transmit beam (e.g., the third transmit beam 331-3) based on the result of the signal reception operation through the receive beam sweeping 340.

As described above, after the communicable transmit and receive beams are determined, the base station 320 and the electronic device 101 may transmit and/or receive basic information for cell setting, and based on the information, set information for additional beam operation. For example, the beam operation information may include detailed information on a set beam, SS/PBCH Block, CSI-RS, or setting information on an additional reference signal.

In addition, the electronic device 101 may continuously monitor the channel and the strength of the beam by using at least one of the SS/PBCH Block and CSI-RS included in the transmit beam. The electronic device 101 may adaptively select a beam having good beam quality by using the monitoring operation. Optionally, when a communication is disconnected due to movement of the electronic device 101 or blocking of a beam, the above-mentioned beam sweeping operation may be performed again to determine a communicable beam.

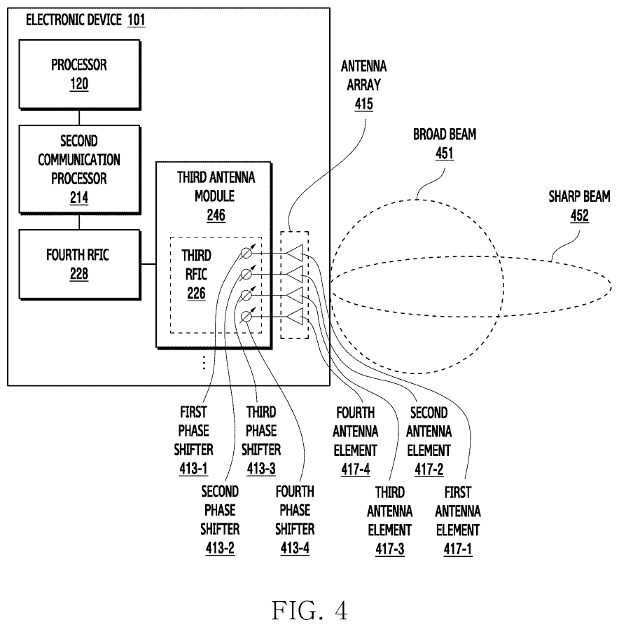

FIG. 4 illustrates a block diagram of the electronic device 101 for 5G network communication, according to an embodiment. The electronic device 101 may include various components illustrated in FIG. 2; however, for brief description, FIG. 4 illustrates the electronic device 101 as including the processor 120, the second communication processor 214, the fourth RFIC 228, and at least one third antenna module 246.

In the illustrated embodiment, the third antenna module 246 may include first to fourth phase shifters 413-1 to 413-4 (e.g., the phase shifter 238 in FIG. 2) and/or first to fourth antenna elements 417-1 to 417-4 (e.g., the antenna 248 in FIG. 2). Each of the first to fourth antenna elements 417-1 to 417-4 may be electrically connected, directly or indirectly, to one of the first to fourth phase shifters 413-1 to 413-4 individually. The first to fourth antenna elements 417-1 to 417-4 may form at least one antenna array 415.

The second communication processor 214 may control the first to fourth phase shifters 413-1 to 413-4, thereby controlling the phases of the transmitted and/or received signals through the first to fourth antenna elements 417-1 to 417-4, which makes it possible to generate a transmit beam and/or a receive beam in a selected direction.

According to an embodiment, the third antenna module 246 may form a beam 451 of the broad radiation pattern (hereinafter, referred to as a ‘broad beam’) or a beam 452 of the sharp radiation pattern (hereinafter, referred to as a ‘sharp beam’) as mentioned above, depending on the number of the used antenna elements. For example, the third antenna module 246 may form the sharp beam 452 when all of the first to fourth antenna elements 417-1 to 417-4 are used, and form the broad beam 451 when only the first antenna element 417-1 and the second antenna element 417-2 are used. The broad beam 451 has a broader coverage than the sharp beam 452, but has a small antenna gain, and thus it may be more effective in searching for a beam. On the other hand, the sharp beam 452 has a narrower coverage than the broad beam 451, but has a higher antenna gain, and thus it may improve communication performance.

According to an embodiment, the second communication processor 214 may utilize a sensor module 176 (e.g., a 9-axis sensor, grip sensor, or GPS) for beam search. For example, the electronic device 101 may adjust a beam search position and/or a beam search period based on the position and/or movement of the electronic device 101 by using the sensor module 176. For another example, when the electronic device 101 is gripped by a user, an antenna module having better communication performance may be selected from among the plurality of third antenna modules 246 by identifying the gripping part of the user using a grip sensor.

According to an embodiment, a processor (e.g., the processor 120 of FIG. 1) of an electronic device (e.g., the electronic device 101 of FIG. 1) may communicate with a first base station, in a frequency range (FR) 2 band. While communicating with the first base station, the electronic device may identify that quality (or magnitude) of at least one signal satisfies a designated condition from a second base station. The electronic device may perform a handover from the first base station to the second base station. For example, the same antenna module (hereinafter, a first antenna module) may be used to receive at least one signal from the first base station and the second base station. The electronic device may receive at least one signal from the first base station through a first receiving beam formed using the first antenna module. The electronic device may receive at least one signal from the second base station through a second receiving beam formed using the first antenna module. The electronic device may not be able to simultaneously form the first receiving beam and the second receiving beam using the first antenna module.

According to an embodiment, when different receiving beams are formed using the same antenna module, the electronic device may perform the handover from the first base station to the second base station based on transmitting a message to the first base station. According to an embodiment, when different receiving beams are formed using the same antenna module, the electronic device may perform the handover from the first base station to the second base station by controlling the first receiving beam and the second receiving beam.

A detailed operation of the electronic device (or a processor of the electronic device) for the above-described embodiment may be described below. An electronic device described below may correspond to the electronic device 101 of FIG. 1.

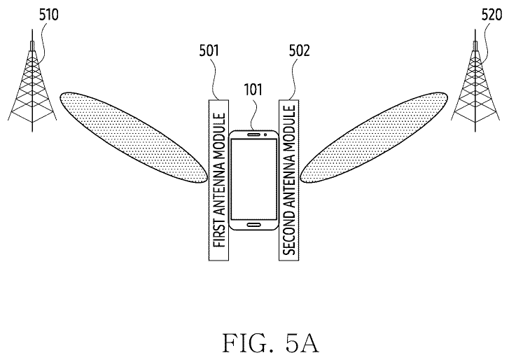

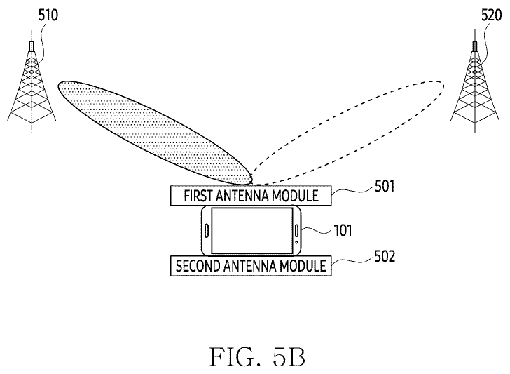

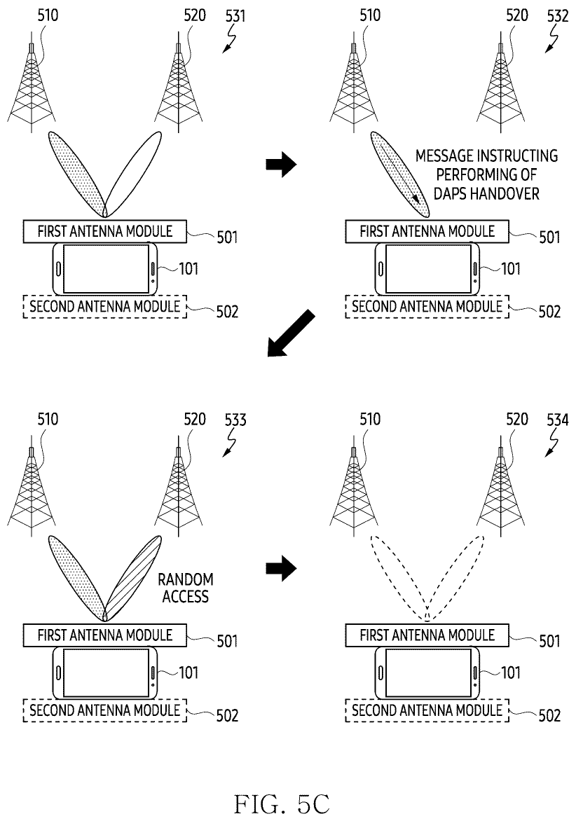

FIGS. 5A to 5C illustrate an example in which handover is performed in an electronic device.

Referring to FIG. 5A, an electronic device 101 may include a first antenna module 501 and a second antenna module 502. The electronic device 101 may communicate with a first base station 510 through a first beam (e.g., a transmitting beam or receiving beam) formed using the first antenna module 501. For example, the electronic device 101 may communicate with the first base station 510 within a FR 2 band through a first beam formed using the first antenna module 501.

For example, the electronic device 101 may receive first data from the first base station 510 through a first receiving beam formed using the first antenna module 501. The electronic device 101 may identify at least one signal (e.g., a synchronization signal block (SSB) signal) transmitted from a second base station 520. The electronic device 101 may identify a second receiving beam based on at least one signal transmitted from the second base station. For example, the electronic device 101 may perform beam sweeping based on at least one signal received from the second base station. The electronic device 101 may identify the second receiving beam based on the beam sweeping.

The electronic device 101 may identify information for indicating quality of at least one second signal received from the second base station through the second receiving beam, from the second base station 520. The electronic device 101 may transmit a message (e.g., a measurement report message) including information for indicating quality of at least one second signal received through the second receiving beam to the first base station 510, based on information for indicating the quality of at least one second signal received through the second receiving beam satisfying a designated condition. The electronic device 101 may receive information for instructing to perform a handover from the first base station 510 to the second base station 520, based on the transmission of the message. The electronic device 101 may perform the handover based on information for instructing to perform the handover from the first base station 510 to the second base station 520.

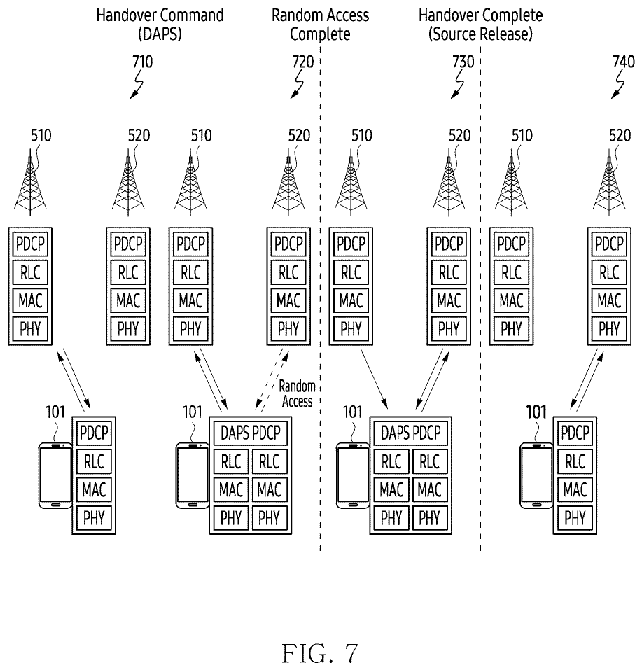

According to an embodiment, based on a dual active protocol stack (DAPS), the electronic device 101 may perform a handover (hereinafter, referred to as a DAPS handover). For example, the electronic device 101 may establish (or generate) a connection with the second base station 520 before releasing a connection with the first base station 510. After the connection with the second base station 520 is completed, the electronic device 101 may release the connection with the first base station 510. A specific example in which the DAPS handover is performed will be described later with reference to FIG. 7.

Referring to FIG. 5B, the electronic device 101 may include the first antenna module 501 and the second antenna module 502. The electronic device 101 may communicate with the first base station 510 through a first beam formed using the first antenna module 501. For example, the electronic device 101 may receive first data from the first base station 510 through the first receiving beam formed using the first antenna module 501. The electronic device 101 may identify at least one signal transmitted from the second base station 520. The electronic device 101 may identify the second receiving beam based on the at least one signal transmitted from the second base station.

The electronic device 101 may identify that the first antenna module 501 is used to form the second receiving beam. An antenna module used for forming the second receiving beam may be changed based on a posture of the electronic device 101.

For example, the electronic device 101 may identify that both the first receiving beam and the second receiving beam are formed using the first antenna module 501. The electronic device 101 may not be able to simultaneously form the first receiving beam and the second receiving beam by using the first antenna module 501. In addition, the first base station 510 may not be able to identify that the first receiving beam and the second receiving beam are formed using the same first antenna module 501.

A problem occurring when the electronic device 101 simultaneously receives data from the first base station 510 and the second base station 520 through the first receiving beam and the second receiving beam formed using the first antenna module 501 may be described through FIG. 5C.

Referring to FIG. 5C, in a state 531, the electronic device 101 may operate in connection with the first base station 510. While the electronic device 101 communicates with the first base station 510, the processor 120 may perform a beam monitoring procedure. For example, the electronic device 210 may periodically perform beam sweeping while communicating with the first base station 510. The electronic device 101 may receive at least one first signal (e.g., an SSB signal) from the first base station 510. The electronic device 101 may receive at least one second signal (e.g., an SSB signal) from the second base station 520. The electronic device 101 may identify the first receiving beam among a plurality of receiving beams, based on the at least one first signal. The electronic device 101 may identify the second receiving beam among the plurality of receiving beams, based on the at least one second signal. The first receiving beam and the second receiving beam may be formed using the first antenna module 501.

The electronic device 101 may transmit a message (e.g., a measurement report message) including first information for indicating the quality of the at least one first signal received through the first receiving beam and second information for indicating the quality of the at least one second signal received through the second receiving beam to the first base station 510. The first base station 510 may receive a message including the first information and the second information from the electronic device 101.

In a state 532, the first base station 510 may transmit a message instructing performing of the DAPS handover to the electronic device 101, based on the first information and the second information. For example, before transmitting the message instructing performing of the DAPS handover, the first base station 510 may transmit information for setting the DAPS handover to the electronic device 101. The electronic device 101 may identify information on a DAPS handover scheme (or procedure) based on the information for setting the DAPS handover. After transmitting the information for setting the DAPS handover, the first base station 510 may identify (or determine) that the electronic device 101 will perform the DAPS handover without considering that the first receiving beam and the second receiving beam are formed through the same antenna module. The electronic device 101 may receive the message instructing performing of the DAPS handover from the first base station 510.

In a state 533, while receiving data from the first base station 510 through the first receiving beam, the electronic device 101 may perform random access through the second receiving beam from the second base station 520.

In a state 534, the electronic device 101 may be allocated resources for simultaneously receiving data from the first base station 510 and the second base station 520. In this case, the electronic device 101 may have to receive data through only one of the first receiving beam and the second receiving beam. The electronic device 101 may not properly perform receiving data from the first base station 510 and the second base station 520 until the DAPS handover is completed and the connection with the first base station 510 is released.

In the following specification, various embodiments for solving the above-described problem may be proposed.

According to an embodiment, the electronic device 101 may configure a message (e.g., a measurement report message) transmitted to the first base station 510 so that a handover (hereinafter, the DAPS handover) is not performed, based on the DAPS.

For example, the electronic device 101 may transmit a message including information for indicating the quality of the at least one second signal (e.g., SSB signal) received from the second base station 520 through a third receiving beam formed using the second antenna module 502 to the first base station 510.

For another example, the electronic device 101 may transmit a message including information for indicating that the first receiving beam and the second receiving beam are formed using the same first antenna module 501, to the first base station 510.

According to an embodiment, the electronic device 101 may identify fake radio link failure (RLF) in order to release the connection with the first base station 510. For example, the electronic device 101 may identify the fake RLF. The electronic device 101 may identify that the connection with the first base station 510 is released, based on the fake RLF. For example, the electronic device 101 may perform the handover from the first base station 510 to the second base station 520 by releasing the connection with the first base station 510 and establishing a connection with the second base station 520, based on the fake RLF. For example, the electronic device 101 may deactivate an antenna for connection with the first base station 510 based on the fake RLF. The electronic device 101 may release the connection with the first base station 510 by deactivating the antenna for connection with the first base station 510.

According to an embodiment, the electronic device 101 may identify the third receiving beam formed using the second antenna module 502. The electronic device 101 may identify information for indicating the quality of the at least one second signal received through the third receiving beam formed using the second antenna module 502.

For example, based on the information for indicating the quality of the at least one second signal received through the third receiving beam satisfying a designated condition, the electronic device 101 may perform the handover (e.g., DAPS handover) from the first base station 510 to the second base station 520 by releasing the connection with the first base station 510 and establishing the connection with the second base station 520.

For another example, based on the information for indicating the quality of the at least one second signal received through the third receiving beam satisfying the designated condition, the electronic device 101 may perform the handover (e.g., DAPS handover) from the first base station 510 to the second base station 520 by identifying that the connection with the first base station 510 is released and establishing the connection with the second base station 520.

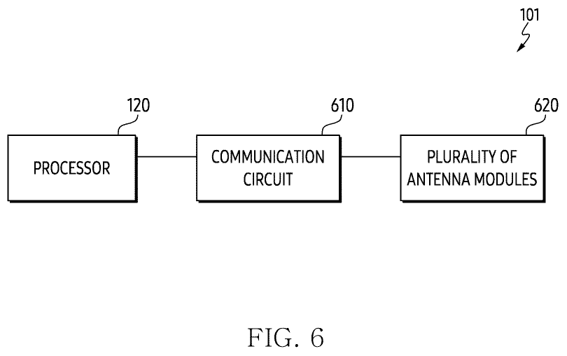

FIG. 6 is a simplified block diagram of an electronic device according to various embodiments.

Referring to FIG. 6, an electronic device 101 of FIG. 6 may at least partially correspond to the electronic device 101 of FIG. 1. According to an embodiment, the electronic device 101 may be a terminal owned by a user. For example, the terminal may include a personal computer (PC) such as a laptop and a desktop, a smartphone, a smart pad, a tablet PC, a smartwatch, and a smart accessory such as a head-mounted device (HMD). In an embodiment, the electronic device 101 may be a user equipment (UE) communicating with a base station. In an embodiment, the electronic device 101 may be an intermediate node assisting communication between a first external electronic device and a second external electronic device. For example, the electronic device 101 may be an access point (AP) or a customer-premises equipment (CPE). However, it is not limited thereto.

The electronic device 101 may include a processor 120, a communication circuit 610, and/or a plurality of antenna modules 620. According to an embodiment, the electronic device 101 may include at least one of the processor 120, a communication circuit 610, and a plurality of antenna modules 620. For example, the at least a part of the processor 120, the communication circuit 610, and the plurality of antenna modules 620 may be omitted according to embodiments.

According to an embodiment, the processor 120 may control the communication circuit 610. The communication circuit 610 may be controlled by the processor 120. The processor 120 may include a hardware component for processing data based on one or more instructions. For example, the hardware component for processing data may include an arithmetic and logic unit (ALU), a field programmable gate array (FPGA), and/or a central processing unit (CPU).

For example, the number of the processors 120 may be one or more. For example, the processor 120 may have a structure of a multi-core processor such as a dual core, a quad core, or a hexa core.

For example, the processor 120 may include a communication processor (CP). The communication processor may operate to support wireless communication related to one or more functions executed by the processor 120.

According to an embodiment, the communication circuit 610 may be used to communicate with an external electronic device (or a base station). For example, the communication circuit 610 may correspond to the communication module 190 of FIG. 1. For example, the communication circuit 610 may be connected, directly or indirectly, to the plurality of antenna modules 620. The processor 120 may transmit and/or receive a signal for wireless communication, by using at least one antenna module among the plurality of antenna modules 620 connected, directly or indirectly, to the communication circuit 610.

The plurality of antenna modules 620 may correspond to the antenna module 197 of FIG. 1. For example, the plurality of antenna modules 620 may form a mmWave antenna module. Each of the plurality of antenna modules 620 may be connected, directly or indirectly, to the communication circuit 610.

FIG. 7 illustrates an example in which DAPS handover is performed, according to various embodiments.

Referring to FIG. 7, in a state 710, a processor 120 of an electronic device 101 may communicate with a first base station 510. The electronic device 101 may be located within a cell formed by the first base station 510. The electronic device 101 may communicate with the first base station 510 within the cell formed by the first base station 510. The electronic device 101 may receive a signal from a second base station 520 while communicating with the first base station 510. The electronic device 101 may transmit information on quality of a signal received from the first base station 510 and information on quality of a signal received from the second base station 520 to the first base station 510. The processor 120 may be instructed from the first base station 510 to perform a handover based on a dual active protocol stack (DAPS). For example, the processor 120 may be instructed from the first base station 510 to perform the DAPS handover.

In a state 720, the processor 120 may perform a random access with the second base station 520 while being connected to the first base station 510. For example, the processor 120 may generate two protocol stacks. The processor 120 may generate a first protocol stack and a second protocol stack. The processor 120 may communicate with the first base station 510 through the first protocol stack. The processor 120 may perform a random access with the second base station 520 through the second protocol stack.

In a state 730, the processor 120 may maintain a connection with the first base station 510 while performing a DAPS handover from the first base station 510 to the second base station 520. For example, the processor 120 may receive data from the first base station 510 and simultaneously receive data from the second base station 520. For example, the processor 120 may transmit data to the second base station 520 while performing the DAPS handover from the first base station 510 to the second base station 520.

In a state 740, the processor 120 may complete the DAPS handover from the first base station 510 to the second base station 520. After completing the DAPS handover, the processor 120 may communicate with the second base station 520. The processor 120 may perform a soft handover in which transmission/reception of data is not interrupted by performing the DAPS handover.

According to an embodiment, the processor 120 may perform the DAPS handover from the first base station 510 to the second base station 520 while communicating with the first base station 510 in a FR 2 band. The processor 120 may communicate with the second base station 520 in the FR 2 band, based on the DAPS handover.

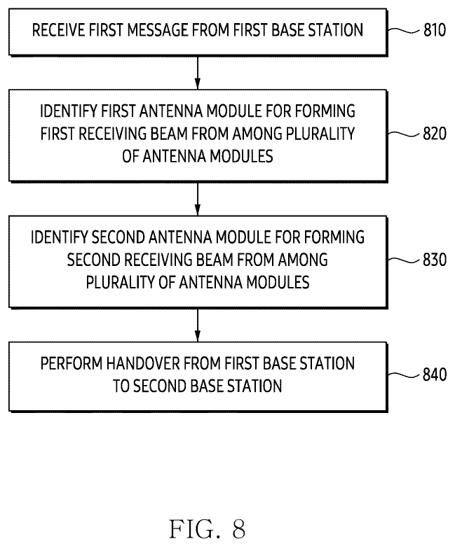

FIG. 8 is a flowchart illustrating an operation of an electronic device according to various embodiments.

Referring to FIG. 8, an electronic device 101 may include a plurality of antenna modules. In operation 810, the processor 120 may receive a first message from a first base station. For example, the first message may include configuration information of a second message. As an example, the configuration information of the second message may include information for indicating information to be included in the second message. The processor 120 may indicate the information to be included in the second message by transmitting the configuration information of the second message through the first message. For example, the processor 120 may identify (or determine) whether to transmit information on a first antenna module and/or a second antenna module through the second message, based on the configuration information of the second message included in the first message.

The processor 120 may identify the configuration information of the second message, based on the first message. The processor 120 may identify information to be transmitted through the second message, based on the configuration information of the second message. For example, the information on the first antenna module and the second antenna module may be transmitted through the second message. For example, the first base station may be a serving base station of the electronic device 101.

In operation 820, the processor 120 may identify the first antenna module for forming a first receiving beam from among the plurality of antenna modules. The processor 120 may determine the first antenna module for forming the first receiving beam from among the plurality of antenna modules. For example, after receiving the first message, the processor 120 may identify the first antenna module for forming the first receiving beam identified based on at least one first signal (e.g., SSB signal) received from the first base station among the plurality of antenna modules. For example, after receiving the first message, the processor 120 may determine the first antenna module for forming the first receiving beam identified based on the at least one first signal (e.g., SSB signal) received from the first base station from among the plurality of antenna modules.

For example, after receiving the first message, the processor 120 may perform beam sweeping based on the at least one first signal received from the first base station. The processor 120 may identify a first receiving beam having the highest quality of the at least one first signal, among a plurality of receiving beams capable of being formed using the plurality of antenna modules, through the beam sweeping. The processor 120 may form the first receiving beam using the first antenna module among the plurality of antenna modules.

For example, the first base station may transmit a synchronization signal block (SSB) (or a synchronization signal/physical broadcast channel (SS/PBCH) block) based on a designated period. The first base station may transmit the SSB signal every designated period. The processor 120 may receive the SSB signal from the first base station every designated period. The processor 120 may identify the SSB signal transmitted from the first base station every designated period as at least one signal transmitted from the first base station. The processor 120 may identify a value (or a quality value) for quality of the SSB signal received through a plurality of receiving beams. The processor 120 may identify a receiving beam from which the SSB signal is received with the highest quality as the first receiving beam. For example, the value for the quality of the SSB signal may include at least one of reference signal received power (RSRP), reference signal received quality (RSRQ), and received signal strength indicator (RSSI).

In operation 830, the processor 120 may identify the second antenna module for forming a second receiving beam from among the plurality of antenna modules. The processor 120 may determine the second antenna module for forming the second receiving beam from among the plurality of antenna modules. For example, after receiving the first message, the processor 120 may identify the second antenna module for forming the second receiving beam identified based on at least one second signal received from the second base station from among the plurality of antenna modules. For example, after receiving the first message, the processor 120 may determine the second antenna module for forming the second receiving beam identified based on the at least one second signal received from the second base station from among the plurality of antenna modules. For example, the second base station may be a neighbor base station of the first base station that is a serving base station.

For example, after receiving the first message, the processor 120 may perform beam sweeping based on the at least one second signal received from the second base station. The processor 120 may identify a second receiving beam having the highest quality of the at least one second signal, from among the plurality of receiving beams capable of being formed using the plurality of antenna modules, through beam sweeping. The processor 120 may form the second receiving beam using the second antenna module among the plurality of antenna modules. According to an embodiment, the second antenna module may be set to be the same as the first antenna module.

Although operation 830 is illustrated to be performed after operation 820, it is not limited thereto. Operation 830 may be performed before operation 820, or may be performed simultaneously with operation 820.

In operation 840, the processor 120 may perform a handover from the first base station to the second base station. For example, the processor 120 may perform the handover from the first base station to the second base station, based on transmitting the second message including first information for indicating the quality of the at least one first signal received from the first base station through the first receiving beam and second information for indicating the quality of the at least one second signal received from the second base station through the second receiving beam.

According to an embodiment, the processor 120 may identify the first information for indicating the quality of the at least one first signal received from the first base station. For example, the first information may be used to report the quality of the at least one first signal to the first base station. The processor 120 may report the quality of the at least one first signal to the first base station through the first information. For example, the first information may indicate the quality of the at least one first signal. For example, the first information may include a value (or a quality value) for the quality of the at least one first signal.

According to an embodiment, the processor 120 may identify the second information for indicating the quality of the at least one second signal received from the second base station. For example, the second information may be used to report the quality of the at least one second signal to the first base station. The processor 120 may report the quality of the at least one second signal to the first base station through the second information. For example, the second information may indicate the quality of the at least one second signal. For example, the second information may include a value for the quality of the at least one second signal.

According to an embodiment, the processor 120 may identify that the first information and the second information satisfy a designated condition. For example, the first information may include an RSRP value for the at least one first signal. The second information may include an RSRP value for at least one second signal. The processor 120 may identify that the RSRP value of the at least one first signal and the RSRP value of the second signal satisfy a designated condition. The processor 120 may identify that the RSRP value of the at least one second signal is greater than or equal to a designated threshold value than the RSRP value of the at least one first signal.

For example, the designated threshold value may be set to be greater than a threshold value of A3 event, which is a condition of handover. For example, when the threshold value of the A3 event is set to 3 dB, the designated threshold value may be set to 5 dB. The processor 120 may identify that the RSRP value of the at least one second signal is greater than or equal to 5 dB than the RSRP value of the at least one first signal.

According to an embodiment, the processor 120 may transmit the second message to request a handover from the first base station to the second base station, based on identifying that the first information and the second information satisfy the designated condition. In other words, the processor 120 may transmit the second message to induce the handover from the first base station to the second base station, based on identifying that the first information and the second information satisfy the designated condition. For example, the processor 120 may identify that the occurrence (or performing) of the handover is imminent based on identifying that the first information and the second information satisfy the designated condition. The processor 120 may transmit the second message to induce the handover, to the first base station. For example, the processor 120 may transmit the second message satisfying a condition for a handover (e.g., DAPS handover) to be instructed from the first base station based on identifying that the first information and the second information satisfy the designated condition.

According to an embodiment, the processor 120 may identify information on target quality based on an activated data radio bearer. For example, the processor 120 may identify that the target quality is greater than or equal to a designated quality value. The processor 120 may transmit the second message based on the information on the target quality. For example, the processor 120 may transmit the second message, based on identifying that the target quality is greater than or equal to the designated quality value.

For example, the processor 120 may transmit a second message for satisfying a DAPS handover condition to be instructed from the first base station, based on identifying that the target quality is greater than or equal to the designated quality value, to the first base station. For another example, the processor 120 may transmit a second message for avoiding the DAPS handover based on identifying that the target quality is less than the designated quality value, to the first base station.

According to an embodiment, the processor 120 may transmit information on the first antenna module and the second antenna module through the second message based on the configuration information of the second message included in the first message. For example, the processor 120 may identify configuration (or list) of information to be included in the second message based on the configuration information of the second message included in the first message. For example, the processor 120 may identify that the information on the antenna module should be transmitted through the second message based on the configuration information of the second message included in the first message. The processor 120 may transmit the second message including the information on the first antenna module and the second antenna module.

For example, the information on the first antenna module and the second antenna module may include information on whether the first antenna module and the second antenna module are the same. As an example, the information on whether the first antenna module and the second antenna module are the same may be set to 1 bit (or 1 bit information).

For another example, the information on the first antenna module and the second antenna module may include identification information on the first antenna module and identification information on the second antenna module.

According to an embodiment, the processor 120 may receive a third message based on the second message. The processor 120 may receive the third message from the first base station based on transmitting the second message. For example, the third message may include configuration information on handover from the first base station to the second base station. The configuration information on handover may include information on a handover scheme. As an example, the configuration information on handover may include information for instructing performing of the DAPS handover. As another example, the configuration information on handover may include information for instructing performing of a legacy handover.

In the following specification, an example of an operation of the processor 120 of the electronic device 101 for transmitting (or configuring) the second message based on the first message may be described.

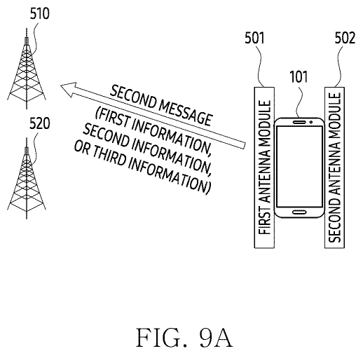

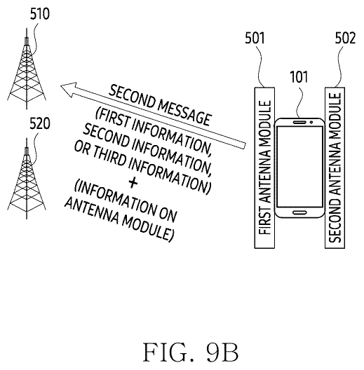

FIGS. 9A to 9B illustrate an example of an operation of an electronic device according to various embodiments.

Referring to FIGS. 9A and 9B, a first antenna module and a second antenna module described in FIG. 8 may be set to be the same. A first antenna module 501 of FIGS. 9A and 9B may correspond to the first antenna module and the second antenna module described in FIG. 8. A second antenna module 502 of FIGS. 9A and 9B may correspond to an antenna module (e.g., a third antenna module) distinct from the first antenna module and the second antenna module described in FIG. 8.

According to an embodiment, the processor 120 may receive a first message from a first base station 510. The processor 120 may identify configuration information of a second message based on the first message. The processor 120 may configure the second message based on the configuration information of the second message. For example, the processor 120 may identify whether to transmit information on an antenna module through the second message, based on the configuration information of the second message. For example, the processor 120 of the electronic device 101 may configure a second message for inducing or avoiding a DAPS handover, based on the first message. The processor 120 may transmit the second message. For example, the second message may include a measurement report message.

According to an embodiment, after receiving the first message, the processor 120 may receive at least one first signal from the first base station. After receiving the first message, the processor 120 may receive at least one second signal from a second base station. For example, the processor 120 may receive the at least one first signal through a plurality of receiving beams capable of being formed through a plurality of antenna modules of the electronic device 101. The processor 120 may receive the at least one second signal through the plurality of receiving beams capable of being formed through the plurality of antenna modules of the electronic device 101.

The processor 120 may identify quality of the at least one first signal received through each of the plurality of receiving beams. The processor 120 may identify quality of the at least one second signal received through each of the plurality of receiving beams. The processor 120 may set a receiving beam in which the quality of the at least one first signal is maximum or high among the plurality of receiving beams as a first receiving beam. The processor 120 may set a receiving beam in which the quality of the at least one second signal is maximum or high among the plurality of receiving beams as a second receiving beam.

According to an embodiment, the first receiving beam and the second receiving beam may be formed through the first antenna module 501 which is the same antenna module. For example, the processor 120 may identify the first antenna module 501 for forming the first receiving beam and the second receiving beam from among the plurality of antenna modules. When the antenna module for forming the first receiving beam and the second receiving beam is the same as the first antenna module 501, the processor 120 may identify (or estimate) whether the DAPS handover will be set.

For example, the processor 120 may determine a possibility of an operation of the DAPS handover. The processor 120 may identify information on the target quality based on an activated data radio bearer (DRB). The processor 120 may identify that the target quality is greater than or equal to a designated quality value. The processor 120 may identify (or estimate) that the DAPS handover will be set, based on identifying that the target quality is greater than or equal to the designated quality value. For example, the processor 120 may identify that an ultra-delay requirement or a high level of reliability is required based on a quality of service (QOS) mapped to the activated DRB. The processor 120 may identify (or determine) that interruption time for the activated DRB is required to be minimized or reduced. Accordingly, the processor 120 may identify that there is a high possibility that the DAPS handover will be set for the activated DRB.

Referring to FIG. 9A, information on the antenna module may not be transmitted through the second message. For example, the processor 120 may identify that information on the antenna module is not included in the second message, based on the configuration information of the second message included in the first message. For another example, the second message may be configured to not include information on the antenna module.

According to an embodiment, when the possibility that the DAPS handover will be set is low, the processor 120 may transmit a second message including first information for indicating the quality of the at least one first signal received from the first base station through the first receiving beam and/or second information for indicating the quality of the at least one second signal received from the second base station through the second receiving beam. As an example, when the possibility that the DAPS handover will be set is low, the processor 120 may transmit first information for indicating a value (or a calculation value) for the quality of the at least one first signal received from the first base station through the first receiving beam and/or second information for indicating a value (or a calculation value) for the quality of the at least one second signal received from the second base station through the second receiving beam. As another example, when the possibility that the DAPS handover will be set is low, the processor 120 may transmit a second message including first information for indicating an average value of the quality of the at least one first signal received from the first base station through the first receiving beam and/or second information for indicating an average value of the quality of the at least one second signal received from the second base station through the second receiving beam. As another example, when the possibility that the DAPS handover will be set is low, the processor 120 may transmit a second message including first information for indicating a maximum value of the quality of the at least one first signal received from the first base station through the first receiving beam and/or second information for indicating a maximum value of the quality of the at least one second signal received from the second base station through the second receiving beam.

For example, the processor 120 may identify (or estimate) that the DAPS handover will not be set. When it is identified that the DAPS handover will not be set, the processor 120 may transmit a second message including first information for indicating the quality of the at least one first signal received from the first base station through the first receiving beam and/or second information for indicating the quality of the at least one second signal received from the second base station through the second receiving beam.

According to an embodiment, when there is a high possibility that the DAPS handover is set, the processor 120 may configure the second message to perform the DAPS handover through different antenna modules. For example, the processor 120 may identify (or estimate) that the DAPS handover will be set. When it is identified that DAPS handover will be set, the processor 120 may configure the second message to perform the DAPS handover through different antenna modules.

For example, even when the second receiving beam is formed using the first antenna module 501, the processor 120 may transmit third information for indicating the quality of the at least one second signal received from the second base station through a third receiving beam formed using the second antenna module 502 through the second message. Accordingly, the processor 120 may transmit a second message including first information for indicating the quality of the at least one first signal received from the first base station through the first receiving beam and/or third information for indicating the quality of the at least one second signal received from the second base station through the third receiving beam. As an example, the processor 120 may transmit a second message including first information for indicating a value (or a calculation value) for the quality of the at least one first signal received from the first base station through the first receiving beam and/or third information for indicating a value (or a calculation value) for the quality of the at least one second signal received from the second base station through the third receiving beam. As another example, the processor 120 may transmit a second message including first information for indicating an average value of the quality of the at least one first signal received from the first base station through the first receiving beam and/or third information for indicating an average value of the quality of the at least one second signal received from the second base station through the third receiving beam. As another example, the processor 120 may transmit a second message including first information for indicating a maximum value of the quality of the at least one first signal received from the first base station through the first receiving beam and/or third information for indicating a maximum value of the quality of the at least one second signal received from the second base station through the third receiving beam.

According to an embodiment, when there is a high possibility that the DAPS handover is set, the processor 120 may transmit the first information and/or the third information identified using different antenna modules through the second message, without transmitting the first information and the second information identified using the same antenna module. The processor 120 may induce (or request) the DAPS handover by transmitting the first information and/or the third information through the second message.

Referring to FIG. 9B, information on an antenna module may be transmitted through the second message. For example, the processor 120 may identify that the information on the antenna module is included in the second message, based on configuration information of the second message included in the first message. For another example, the second message may be configured to include the information on the antenna module.

For example, when the possibility that the DAPS handover will be set is low, the processor 120 may transmit a second message including first information for indicating the quality of the at least one first signal received from the first base station through the first receiving beam and/or second information for indicating the quality of the at least one second signal received from the second base station through the second receiving beam. The second message may further include information on the first antenna module 501 for forming the first receiving beam and/or the second receiving beam.

For example, when the possibility that the DAPS handover will be set is low, the processor 120 may transmit first information for indicating a value (or a calculation value) for the quality of the at least one first signal received from the first base station through the first receiving beam and/or second information for indicating a value (or a calculation value) for the quality of the at least one second signal received from the second base station through the second receiving beam. As another example, when the possibility that the DAPS handover will be set is low, the processor 120 may transmit a second message including first information for indicating an average value of the quality of the at least one first signal received from the first base station through the first receiving beam and/or second information for indicating an average value of the quality of the at least one second signal received from the second base station through the second receiving beam. As another example, when the possibility that the DAPS handover will be set is low, the processor 120 may transmit a second message including first information for indicating a maximum value of the quality of the at least one first signal received from the first base station through the first receiving beam and/or second information for indicating a maximum value of the quality of the at least one second signal received from the second base station through the second receiving beam.

For example, the information on the first antenna module 501 may include information on whether the first information and the second information are identified through the same antenna module. The information on whether the first information and the second information are identified through the same antenna module may be set to 1 bit (or 1 bit information).

As another example, the information on the first antenna module 501 may include information for indicating that the first information and the second information are identified through the same antenna module. The information for indicating that the first information and the second information are identified through the same antenna module may be set to 1 bit (or 1 bit information).

As still another example, the information on the first antenna module 501 may include identification information on the first antenna module 501. The second message may further include the identification information on the first antenna module 501 for forming the first receiving beam and the second receiving beam.

For another example, when there is a high possibility that the DAPS handover is set, the processor 120 may configure the second message to perform the DAPS handover through different antenna modules. For example, even when the second receiving beam is formed using the first antenna module 501, the processor 120 may transmit third information for indicating the quality of the at least one second signal received from the second base station through a third receiving beam formed using the second antenna module 502 through the second message. The processor 120 may transmit a second message including first information for indicating the quality of the at least one first signal received from the first base station through the first receiving beam and third information for indicating the quality of the at least one second signal received from the second base station through the third receiving beam. The second message may further include information on the first antenna module 501 and the second antenna module 502. The processor 120 may transmit the information on the first antenna module 501 and the second antenna module 502 together with the first information and the third information through the second message.

For example, the processor 120 may transmit a second message including first information for indicating a value (or a calculated value) for the quality of at least one first signal received from the first base station through the first receiving beam and/or third information for indicating a value (or a calculated value) for the quality of at least one second signal received from the second base station through the third receiving beam. As another example, the processor 120 may transmit a second message including first information for indicating an average value of the quality of the at least one first signal received from the first base station through the first receiving beam and/or third information for indicating an average value of the quality of the at least one second signal received from the second base station through the third receiving beam. As another example, the processor 120 may transmit a second message including first information for indicating a maximum value of the quality of the at least one first signal received from the first base station through the first receiving beam and/or third information for indicating a maximum value of the quality of the at least one second signal received from the second base station through the third receiving beam.

As an example, information on the first antenna module 501 and the second antenna module 502 may include information on whether the first information and the third information are identified through different antenna modules. The information on whether the first information and the third information are identified through different antenna modules may be set to 1 bit (or 1 bit information).

As another example, information on the first antenna module 501 and the second antenna module 502 may include information for indicating that the first information and the third information are identified through different antenna modules. The information for indicating that the first information and the third information are identified through different antenna modules may be set to 1 bit (or 1 bit information).

As still another example, the information on the first antenna module 501 and the second antenna module 502 may include identification information on the first antenna module 501 and identification information on the second antenna module 502. The second message may further include identification information for the first antenna module 501 for forming the first receiving beam and identification information for the second antenna module 502 for forming the third receiving beam.

Referring back to FIGS. 9A and 9B, after the second message is transmitted, the first base station 510 may determine (or identify) whether to perform handover, based on the second message. For example, the first base station 510 may determine (or identify) a type of handover to be performed by the electronic device 101. As an example, the first base station 510 may determine the handover to be performed by the electronic device 101 as a legacy handover. As another example, the first base station 510 may determine the handover to be performed by the electronic device 101 as the DAPS handover.

According to an embodiment, the processor 120 may receive a third message for instructing the handover from the first base station 510 to the second base station 520 from the first base station 510. For example, the third message may include configuration information on handover from the first base station 510 to the second base station 520. The configuration information on the handover may include information on a type of the handover to be performed by the electronic device 101. The processor 120 may perform the handover from the first base station 510 to the second base station 520 based on the third message.

Unlike the above-described embodiments, according to various embodiments, the first antenna module for forming the first receiving beam identified based on the at least one first signal and the second antenna module for forming the second receiving beam identified based on the at least one second signal may be identified as the same antenna module. In this case, the processor 120 may not be able to perform the DAPS handover.

Even when the first antenna module and the second antenna module are identified as the same antenna module, the processor 120 may receive the third message for instructing performing of the DAPS handover from the first base station 510. Based on the third message, the processor 120 may identify fake RLF or perform the DAPS handover through the same receiving beam (e.g., the second receiving beam).

In the following specification, an example of an operation of the electronic device 101 (or the processor 120 of the electronic device 101) for identifying fake RLF or performing the DAPS handover through the same receiving beam (e.g., the second receiving beam) based on the third message may be described.

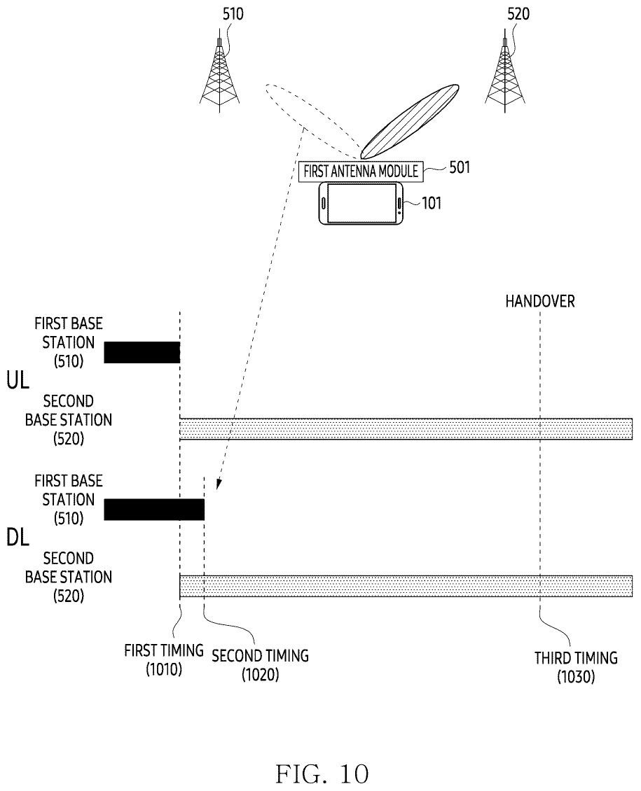

FIG. 10 illustrates another example of an operation of an electronic device according to various embodiments.

Referring to FIG. 10, a processor 120 of an electronic device 101 may identify a first receiving beam and a second receiving beam based on a signal received from a first base station 510 and a second base station. The first receiving beam and the second receiving beam may be formed using the same first antenna module 501.

The processor 120 may receive a message for instructing a DAPS handover from the first base station 510. The processor 120 may not be able to simultaneously use a plurality of beams (e.g., a first receiving beam and a second receiving beam) by using the first antenna module 501. Accordingly, the processor 120 may identify quality of at least one first signal received from the first base station 510 through the second receiving beam formed using the first antenna module 501. The processor 120 may identify that a value (or quality value) for the quality of the at least one first signal received through the second receiving beam is less than a designated value. Based on that the value for the quality of the at least one first signal received through the second receiving beam is less than the designated value, the processor 120 may identify (or determine) that data received from the first base station 510 and the second base station 520 may not be simultaneously received through the second receiving beam.

According to an embodiment, the processor 120 may perform random access (e.g., random access channel (RACH) procedure) with the second base station 520, through the second receiving beam, based on a message for instructing the DAPS handover. The processor 120 may complete the random access at a first timing 1010.

At the first timing 1010, The processor 120 may change a base station for transmitting uplink data from the first base station 510 to the second base station 520. Before the first timing 1010, the processor 120 may transmit uplink data to the first base station 510.

After the first timing 1010, the processor 120 may transmit uplink data to the second base station 520. Even after the first timing 1010, the processor 120 may maintain reception of downlink data (e.g., first data) from the first base station 510. After the first timing 1010, the processor 120 may receive downlink data (e.g., second data) from the second base station 520.

At the first timing 1010, the processor 120 may generate fake radio link failure (fake RLF) in a channel with the first base station 510. The processor 120 may identify the fake RLF in the channel with the first base station 510 at the first timing 1010. The processor 120 may cease receiving the downlink data from the first base station 510 at a second timing 1020. For example, the processor 120 may identify the fake RLF at the first timing 1010. The processor 120 may complete processing for the fake RLF at the second timing 1020. The processor 120 may cease receiving the first data from the first base station 510 from the second timing 1020.

According to an embodiment, after receiving the message for instructing the DAPS handover from the first base station 510, the processor 120 may identify (or determine) that data received from the first base station 510 and the second base station 520 may not be simultaneously received through the second receiving beam. Accordingly, the processor 120 may identify (or predict) that the fake RLF will occur. The processor 120 may cease receiving the first data from the first base station 510 at the timing 1010 in which the random access with the second base station 520 is completed.

For example, the processor 120 may induce to similarly operate to a legacy handover, based on the fake RLF. The processor 120 may operate similarly to the legacy handover, based on the fake RLF. For example, the processor 120 may release a connection with the first base station 510 and establish a connection with the second base station 520, based on the fake RLF. For example, the processor 120 may identify a release of the connection with the first base station 510 and establish the connection with the second base station 520, based on the fake RLF.

According to an embodiment, the processor 120 may cease receiving downlink data from the first base station 510, by identifying the fake RLF before a third timing 1030 when a message instructing completion of the DAPS handover is received from the first base station 510.

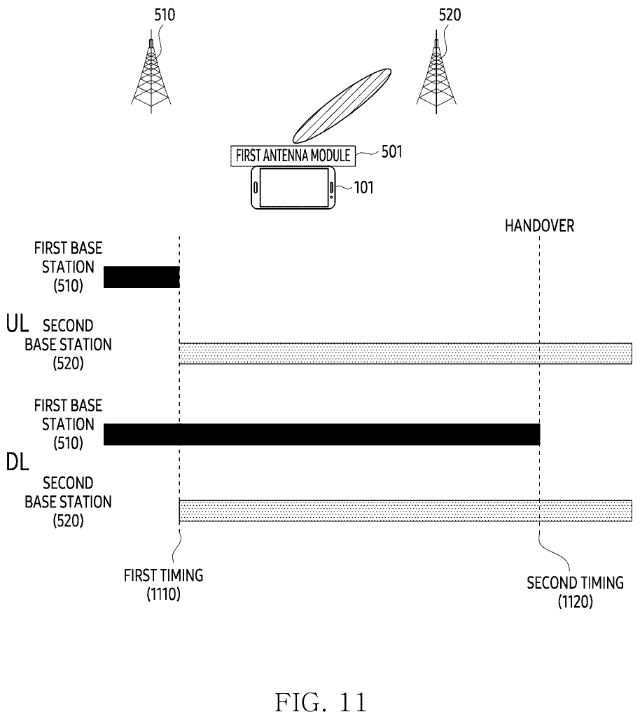

FIG. 11 illustrates another example of an operation of an electronic device according to various embodiments.

Referring to FIG. 11, a processor 120 of an electronic device 101 may identify a first receiving beam and a second receiving beam based on a signal received from a first base station 510 and a second base station. The first receiving beam and the second receiving beam may be formed using the same first antenna module 501.

According to an embodiment, the processor 120 may receive a message for instructing a DAPS handover from a first base station 510. The processor 120 may not be able to use a plurality of beams by using the first antenna module 501. Accordingly, the processor 120 may identify quality of at least one first signal received from the first base station 510 through the second receiving beam formed through the first antenna module 501. The processor 120 may identify that a value (or quality value) for the quality of the at least one first signal received through the second receiving beam is greater than or equal to a designated value. Based on that the value for the quality of the at least one first signal received through the second receiving beam is greater than or equal to the designated value, the processor 120 may identify (or determine) that data received from the first base station 510 and the second base station 520 may be simultaneously received through the first antenna module 501. The processor 120 may perform the DAPS handover through the second receiving beam formed using the first antenna module 501.

According to an embodiment, the processor 120 may receive downlink data (hereinafter, first data) from the first base station 510 through the second receiving beam formed using the first antenna module 501. In addition, the processor 120 may receive downlink data (hereinafter, second data) from the second base station 520 through the second receiving beam formed using the first antenna module 501. The processor 120 may simultaneously receive the first data and the second data through the second receiving beam. The processor 120 may perform the DAPS handover from the first base station 510 to the second base station 520, based on the first data received from the first base station 510 through the second receiving beam and the second data received from the second base station 520 through the second receiving beam.

According to an embodiment, the processor 120 may receive a message for instructing the DAPS handover from the first base station 510, while communicating with the first base station 510 through the first receiving beam. The processor 120 may change (or switch) a receiving beam for communicating with the first base station 510 from the first receiving beam to the second receiving beam. For example, in response to receiving data through the second receiving beam from the second base station 520, the processor 120 may change (or switch) a receiving beam for communicating with the first base station 510 from the first receiving beam to the second receiving beam. For another example, after receiving data through the second receiving beam from the second base station 520, the processor 120 may change (or switch) a receiving beam for communicating with the first base station 510 from the first receiving beam to the second receiving beam.

For example, the second receiving beam may indicate a receiving beam in which the quality of the at least one second signal received from the second base station 520 is maximum. The processor 120 may receive data through the second receiving beam from both the first base station 510 and the second base station 520, and may perform the DAPS handover from the first base station 510 to the second base station 520.

According to an embodiment, the processor 120 may perform random access (e.g., random access channel (RACH) procedure) with the second base station 520, through the second receiving beam based on the message for instructing the DAPS handover. The processor 120 may complete the random access at a first timing 1110.

At the first timing 1110, the processor 120 may change a base station for transmitting uplink data from the first base station 510 to the second base station 520. The processor 120 may transmit uplink data to the first base station 510, before the first timing 1110. After the first timing 1110, the processor 120 may transmit uplink data to the second base station 520.

The processor 120 may maintain reception of downlink data (e.g., first data) from the first base station 510 even after the first timing 1110. For example, before the first timing 1110, the processor 120 may receive downlink data from the first base station 510 through the first receiving beam. From the first timing 1110 until the second timing 1120, the processor 120 may receive downlink data from the first base station 510 through the second receiving beam. After the first timing 1110, the processor 120 may receive downlink data (e.g., second data) from the second base station 520 through the second receiving beam.

At the second timing 1120, the processor 120 may complete the handover. For example, the processor 120 may maintain reception of downlink data through the second receiving beam even after the second timing 1120.

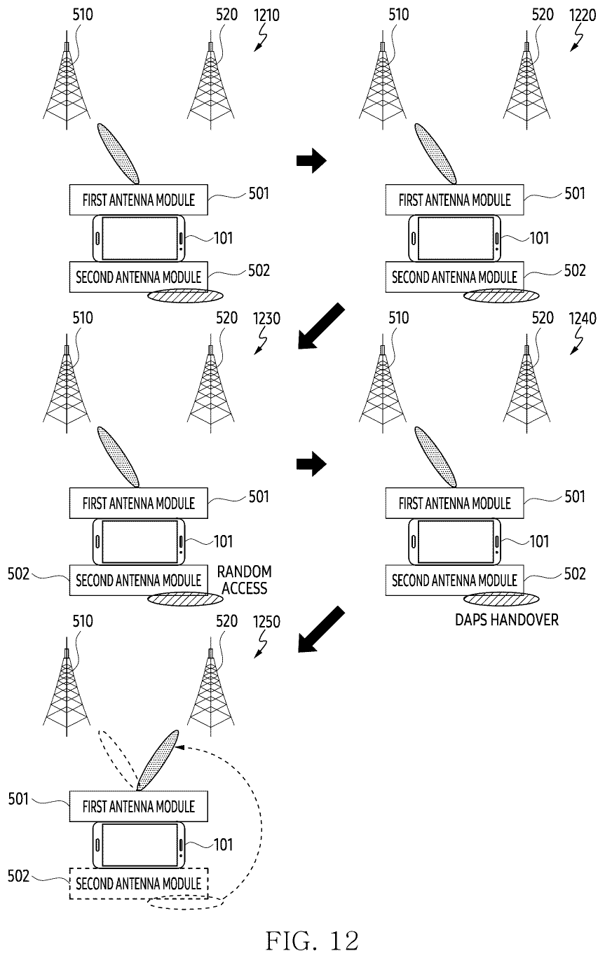

FIG. 12 illustrates another example of an operation of an electronic device according to various embodiments.

Referring to FIG. 12, in a state 1210, an electronic device 101 may operate in connection with a first base station 510. While communicating with a first base station 510, a processor 120 of the electronic device 101 may perform a beam monitoring procedure (e.g., beam sweeping).

According to an embodiment, the processor 120 may receive a first message from the first base station 510. For example, the first message may include configuration information of a second message (e.g., measurement report message).

According to an embodiment, the processor 120 may receive at least one first signal from the first base station 510. The processor 120 may receive at least one second signal from a second base station 520. The processor 120 may identify a first receiving beam among a plurality of receiving beams, based on the at least one first signal. The processor 120 may identify a second receiving beam among the plurality of receiving beams, based on the at least one second signal. The first receiving beam and the second receiving beam may be formed using a first antenna module 501. The processor 120 may identify that both the first receiving beam and the second receiving beam are formed using the first antenna module 501.

Considering that a DAPS handover may be instructed from the first base station 510, the processor 120 may form a receiving beam to receive each data transmitted from the first base station 510 and the second base station 520 through different antenna modules. For example, the processor 120 may identify a third receiving beam among the plurality of receiving beams formed using the second antenna module 502. The third receiving beam may be set to a receiving beam in which quality of the at least one second signal is maximum, among the plurality of receiving beams formed using the second antenna module 502. The processor 120 may identify the quality of the at least one second signal received through the third receiving beam.

The processor 120 may transmit a second message (e.g., a measurement report message) including first information for indicating the quality of the at least one first signal received through the first receiving beam and second information for indicating the quality of the at least one second signal received through the third receiving beam to the first base station 510. The first base station 510 may receive a message including the first information and the second information from the electronic device 101.

In a state 1220, the first base station 510 may transmit a message for instructing the electronic device 101 to perform the DAPS handover. The processor 120 may receive a message for instructing to perform the DAPS handover from the first base station 510.

In a state 1230, while receiving data from the first base station 510 through the first receiving beam formed using the first antenna module 501, the processor 120 may perform random access (e.g., RACH procedure) with the second base station 520 through the third receiving beam formed using the second antenna module 502.

In a state 1240, the processor 120 may receive data from the first base station 510 through the first receiving beam formed using the first antenna module 501, and simultaneously receive data from the second base station 520 through a third receiving beam formed using the second antenna module 502.

In a state 1250, the processor 120 may release a connection with the first base station 510 after the DAP handover is completed. After the connection with the first base station 510 is released, the processor 120 may perform beam monitoring. The processor 120 may change a receiving beam to an optimal beam for receiving data from the second base station 520. For example, the processor 120 may change (or switch or update) a receiving beam for receiving data from the second base station 520 to a fourth receiving beam from the third receiving beam. The processor 120 may maintain the connection with the second base station 520, and may change a receiving beam for receiving data from the second base station 520 from the third receiving beam to the fourth receiving beam.

According to an embodiment, the fourth receiving beam may include the second receiving beam identified in the state 1210. After the connection with the first base station 510 is released, the processor 120 may change the receiving beam for receiving data from the second base station 520 from the third receiving beam to the second receiving beam, without performing beam monitoring.

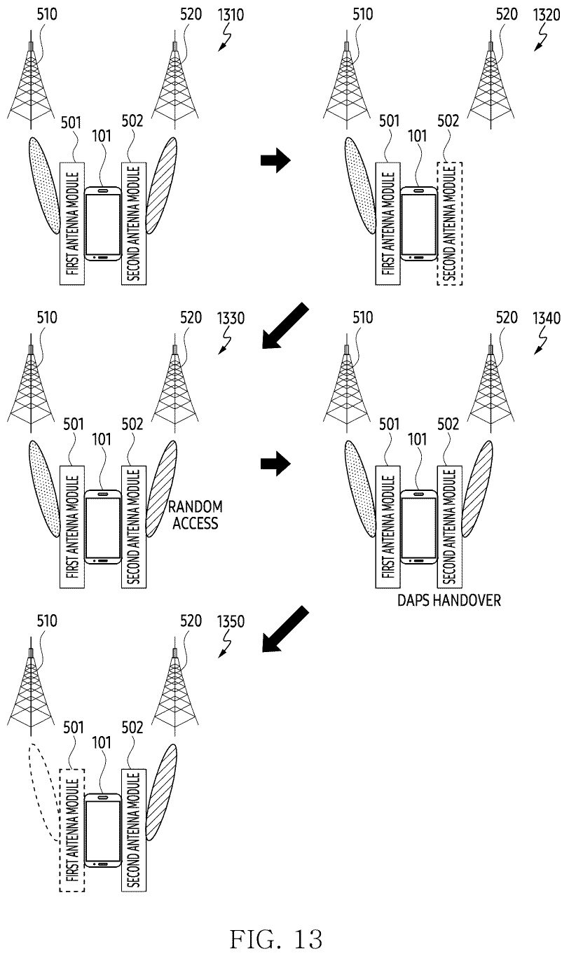

FIG. 13 illustrates another example of an operation of an electronic device according to various embodiments.

Referring to FIG. 13, in a state 1310, an electronic device 101 may operate in connection with a first base station 510. While communicating with the first base station 510, a processor 120 of the electronic device 101 may perform a beam monitoring procedure. The processor 120 may receive a first message from the first base station 510. For example, the first message may include configuration information of a second message (e.g., a measurement report message).

The processor 120 may receive at least one first signal from the first base station 510. The processor 120 may receive at least one second signal from a second base station 520. The processor 120 may identify a first receiving beam among a plurality of receiving beams, based on the at least one first signal. The processor 120 may identify a second receiving beam among the plurality of receiving beams, based on the at least one second signal. The first receiving beam may be formed using a first antenna module 501. The second receiving beam may be formed using a second antenna module 502.

The processor 120 may transmit a second message (e.g., a measurement report message) including first information for indicating quality of the at least one first signal received through the first receiving beam and second information for indicating quality of the at least one second signal received through the second receiving beam to the first base station 510. The first base station 510 may receive a second message including the first information and the second information from the electronic device 101. According to an embodiment, the processor 120 may further include identification information of the first antenna module 501 used to form the first receiving beam and identification information of the second antenna module 502 used to form the second receiving beam in the second message. The processor 120 may transmit the identification information of the first antenna module 501 and the identification information of the second antenna module 502 through the second message, together with the first information and the second information. According to an embodiment, the processor 120 may further include information for indicating that the first information and the second information are identified based on different antenna modules in the second message. The processor 120 may transmit information for indicating that the first information and the second information are identified based on different antenna modules through the second message, together with the first information and the second information.

In a state 1320, the first base station 510 may transmit a message for instructing the electronic device 101 to perform the DAPS handover. The processor 120 may receive a message for instructing to perform the DAPS handover from the first base station 510.

In a state 1330, the processor 120 may perform random access (e.g., RACH procedure) with the second base station 520 through the second receiving beam formed using the second antenna module 502, while receiving data from the first base station 510 through the first receiving beam formed using the first antenna module 501.

In a state 1340, the processor 120 may receive data from the first base station 510 through a first receiving beam formed using the first antenna module 501, and simultaneously receive data from the second base station 520 through the second receiving beam formed using the second antenna module 502. The processor 120 may perform the DAPS handover based on data received from the first base station 510 through the first receiving beam and data received from the second base station 520 through the second receiving beam.

In a state 1350, the processor 120 may release a connection with the first base station 510 after the DAPS handover is completed. After the connection with the first base station 510 is released, the processor 120 may maintain a connection with the second base station 520 through the second receiving beam formed using the second antenna module 502. For example, after the connection with the first base station 510 is released, the processor 120 may receive data from the second base station 520 through the second receiving beam formed using the second antenna module 502.

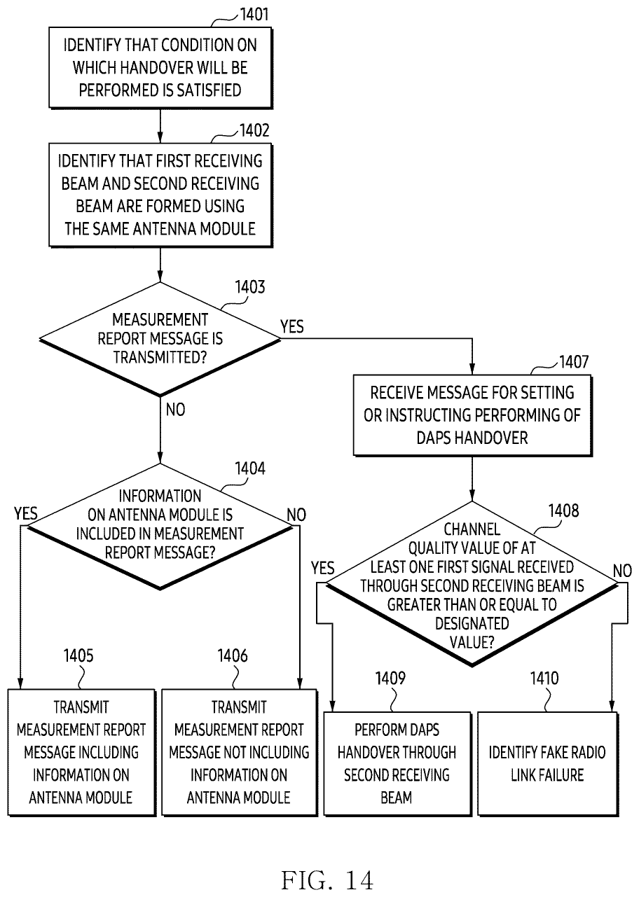

FIG. 14 is a flowchart illustrating another operation of an electronic device according to various embodiments.

Referring to FIG. 14, in operation 1401, a processor 120 may identify that a condition for performing a handover is satisfied. For example, the processor 120 may identify (or determine) that occurrence of handover is imminent. For example, the processor 120 may identify that performing of handover is scheduled.

According to an embodiment, the processor 120 may perform beam sweeping based on at least one first signal received from a first base station. The processor 120 may identify a first receiving beam having the highest quality among a plurality of receiving beams capable of being formed using a plurality of antenna modules, through the beam sweeping. The processor 120 may form the first receiving beam using a first antenna module among the plurality of antenna modules.

According to an embodiment, the processor 120 may perform beam sweeping based on at least one second signal received from a second base station. The processor 120 may identify a second receiving beam having the highest quality among the plurality of receiving beams capable of being formed using the plurality of antenna modules, through beam sweeping. The processor 120 may form the second receiving beam using a second antenna module among the plurality of antenna modules.

According to an embodiment, the processor 120 may identify first information for indicating quality of the at least one first signal received from the first base station through the first receiving beam. The processor 120 may identify first information for reporting quality of the at least one first signal received from the first base station through the first receiving beam. The first information may include a value for the quality of the at least one first signal. For example, the first information may include an RSRP value for the at least one first signal. The processor 120 may identify second information for indicating quality of the at least one second signal received from the second base station through the second receiving beam. The second information may include a value for the quality of the at least one second signal. For example, the second information may include an RSRP value for the at least one second signal.

The processor 120 may identify that a difference between the RSRP value for the at least one second signal and the RSRP value for the at least one first signal is greater than or equal to a designated threshold value. For example, the designated threshold value may be set to be greater than a threshold value of A3 event that is a condition of handover. For example, when the threshold value of the A3 event is set to 3 dB, the designated threshold value may be set to 5 dB. The processor 120 may identify that the RSRP value of the at least one second signal is greater than or equal to 5 dB than the RSRP value of the at least one first signal.

Based on identifying that the difference between the RSRP value for the at least one second signal and the RSRP value for the at least one first signal is greater than or equal to the designated threshold value, the processor 120 may identify that the condition on which the handover will be performed is satisfied. For example, the processor 120 may identify that performing of handover is scheduled based on identifying that the difference between the RSRP value for the at least one second signal and the RSRP value for the at least one first signal is greater than or equal to the designated threshold value.

In operation 1402, the processor 120 may identify that the first receiving beam and the second receiving beam are formed using the same antenna module. For example, it may be identified that a first antenna module used to form the first receiving beam and a second antenna module used to form the second receiving beam are the same.

In operation 1403, the processor 120 may identify whether a measurement report message is transmitted. For example, the processor 120 may identify whether the measurement report message is transmitted based on identifying that the first antenna module and the second antenna module are the same.

In operation 1404, when the measurement report message is not transmitted, the processor 120 may identify whether information on the antenna module is included in the measurement report message. For example, the processor 120 may receive configuration information of the measurement report message from the first base station. The configuration information of the measurement report message may include information indicating whether information on the antenna module is included the measurement report message. The processor 120 may identify whether information on the antenna module is included in the measurement report message based on the configuration information of the measurement report message.

In operation 1405, when information on the antenna module is included in the measurement report message, the processor 120 may transmit a second message including first information for indicating the quality of the at least one first signal received from the first base station through the first receiving beam and second information for indicating the quality of the at least one second signal received from the second base station through the second receiving beam to the first base station. In addition, the processor 120 may transmit information on the first antenna module and the second antenna module to the first base station through the second message, together with the first information and the second information.

For example, the information on the first antenna module and the second antenna module may include information on whether a channel measurement operation is performed based on the first antenna module and the second antenna module. For another example, the information on the first antenna module and the second antenna module may include information on that the channel measurement operation is performed based on the first antenna module among the first antenna module and the second antenna module. For another example, the information on the first antenna module and the second antenna module may include information on that the channel measurement operation is performed based on the second antenna module among the first antenna module and the second antenna module.

For example, the information on the first antenna module and the second antenna module may include information on whether the first antenna module and the second antenna module are the same. The information on whether the first antenna module and the second antenna module are the same may be set to 1 bit. For example, when the first antenna module and the second antenna module are the same, the 1 bit may be set to a first value. For another example, when the first antenna module and the second antenna module are distinguished from each other, the 1 bit may be set to a second value.

For another example, the information on the first antenna module and the second antenna module may include identification information on the first antenna module and identification information on the second antenna module.

In operation 1406, when the information on the antenna module is not included in the measurement report message, the processor 120 may transmit the measurement report message not including the information on the antenna module. The processor 120 may transmit the second message including first information for indicating the quality of the at least one first signal received from the first base station through the first receiving beam and/or second information for indicating the quality of the at least one second signal received from the second base station through the second receiving beam to the first base station. The processor 120 may not transmit information on the first antenna module and the second antenna module.

According to an embodiment, the processor 120 may transmit the second message including the first information for indicating the quality of the at least one first signal received from the first base station through the first receiving beam to the first base station. For example, the processor 120 may transmit the second message including first information for indicating an average value of the quality of the at least one first signal received from the first base station through the first receiving beam to the first base station. For another example, the processor 120 may transmit the second message including first information for indicating a maximum value of the quality of the at least one first signal received from the first base station through the first receiving beam to the first base station.

According to an embodiment, the processor 120 may transmit the second message including second information for indicating the quality of the at least one second signal received from the second base station through the second receiving beam to the first base station. For example, the processor 120 may transmit the second message including second information for indicating an average value of the quality of the at least one second signal received from the second base station through the second receiving beam to the first base station. For another example, the processor 120 may transmit the second message including second information for indicating a maximum value of the quality of the at least one second signal received from the second base station through the second receiving beam to the first base station.

According to an embodiment, the processor 120 may transmit the second message including first information for indicating the quality of the at least one first signal received from the first base station through the first receiving beam and second information for indicating the quality of the at least one second signal received from the second base station through the second receiving beam to the first base station. For example, the processor 120 may transmit the second message including first information for indicating an average value of the quality of the at least one first signal received from the first base station through the first receiving beam and second information for indicating an average value of the quality of the at least one second signal received from the second base station through the second receiving beam to the first base station. For another example, the processor 120 may transmit a second message including first information for indicating a maximum value of the quality of the at least one first signal received from the first base station through the first receiving beam and second information for indicating a maximum value of the quality of the at least one second signal received from the second base station through the second receiving beam to the first base station.

In operation 1407, when the measurement report message is transmitted, the processor 120 may receive a message for setting or instructing performing of the DAPS handover.

According to an embodiment, the processor 120 may receive configuration information for setting performing of the DAPS handover from the first base station. The processor 120 may sct performing of the DAPS handover based on the configuration information for the DAPS handover procedure.

According to an embodiment, the processor 120 may receive a message instructing performing of the DAPS handover from the first base station. The processor 120 may start the DAPS handover procedure based on the message instructing performing of the DAPS handover.

In operation 1408, the processor 120 may identify whether a value for the quality of the at least one first signal received through the second receiving beam is greater than or equal to a designated value. The processor 120 may identify whether a value for the quality of the at least one first signal received through the second receiving beam is greater than or equal to the designated value, rather than the first receiving beam in which a value for the quality of the at least one first signal is maximum.

According to an embodiment, operation 1408 may be performed regardless of operation 1407. For example, the processor 120 may identify whether a value for the quality of the at least one first signal received through the second receiving beam is greater than or equal to a designated value, before receiving a message instructing performing of the DAPS handover. After identifying whether a value for the quality of the at least one first signal received through the second receiving beam is greater than or equal to a designated value, the processor 120 may receive a message indicating performing of the DAPS handover. The processor 120 may perform one of operation 1409 or operation 1410, based on the message instructing performing of the DAPS handover.

In operation 1409, when the value for the quality of the at least one first signal received through the second receiving beam is greater than or equal to a designated value, the processor 120 may perform the DAPS handover through the second receiving beam. The processor 120 may receive data from the first base station and the second base station through the second receiving beam. The processor 120 may perform the DAPS handover based on data received from the first base station and the second base station through the second receiving beam.

In operation 1410, when the value for the quality of the at least one first signal received through the second receiving beam is less than a designated value, the processor 120 may identify fake RLF. The processor 120 may identify the fake RLF in order to release the connection with the first base station through the first receiving beam. For example, the processor 120 may generate the fake RLF in order to release the connection with the first base station through the first receiving beam. The processor 120 may release the connection with the first base station and establish the connection with the second base station based on the fake RLF.

According to various embodiments, an electronic device may comprise a plurality of antenna modules, a communication circuit connected, directly or indirectly, to the plurality of antenna modules, and at least one processor operably coupled with the communication circuit, wherein the at least one processor may be configured to receive a first message from a first base station which is a serving base station of the electronic device; after receiving the first message, identify a first antenna module for forming a first receiving beam identified based on at least one first signal received from the first base station, among the plurality of antenna modules; after receiving the first message, identify a second antenna module for forming a second receiving beam identified based on at least one second signal received from a second base station which is a neighbor base station of the first base station, among the plurality of antenna modules; and based on transmitting a second message comprising first information for indicating quality of the at least one first signal received from the first base station through the first receiving beam, and second information for indicating quality of the at least one second signal received from the second base station through the second receiving beam, perform handover from the first station to the second station.

According to an embodiment, the at least one processor may be further configured to identify, based on the first message, configuration information of the second message, and transmit, based on the configuration information of the second message, information on the first antenna module and the second antenna module through the second message.

According to an embodiment, the information on the first antenna module and the second antenna module may comprise information on whether the first antenna module and the second antenna module are the same; and the information on whether the first antenna module and the second antenna module are the same may be set to 1 bit.

According to an embodiment, the information on the first antenna module and the second antenna module may comprise identification information on the first antenna module and identification information on the second antenna module.

According to an embodiment, the at least one processor may be further configured to identify that the first information and the second information satisfy a designated condition, and based on identifying that the first information and the second information satisfy the designated condition, transmit the second message for requesting the handover from the first base station to the second base station.

According to an embodiment, the first information may comprise a reference signals received power (RSRP) value of the at least one first signal; wherein the second information may comprise a RSRP value of the at least one second signal; and wherein the at least one processor may be configured to identify that the RSRP value of the at least one first signal and the RSRP value of the at least one second signal satisfy a designated condition.

According to an embodiment, the at least one processor may be configured to identify, based on activated data radio bearer, information on target quality, and generate, based on the information on the target quality, the second message.

According to an embodiment, the at least one processor may be configured to identify that the target quality is greater than or equal to a designated quality value, and based on identifying that the target quality is greater than or equal to the designated quality value, generate the second message.

According to an embodiment, the at least one processor may be configured to perform, based on dual active protocol stack, DAPS, the handover from the first base station to the second base station.

According to an embodiment, the first receiving beam may be set to a receiving beam in which the quality of the at least one first signal is maximum among a plurality of receiving beams formed through the plurality of antenna modules; and the second receiving beam may be set to a receiving beam in which the quality of the at least one second signal is maximum among the plurality of receiving beams formed through the plurality of antenna modules.

According to an embodiment, the at least one processor may be configured to receive, based on transmitting the second message, a third message from the first base station; and wherein the third message may comprise configuration information on the handover from the first base station to the second base station.

According to an embodiment, the at least one processor may be configured to identify the second antenna module corresponding to the first antenna module; based on identifying the second antenna module corresponding to the first antenna module, identify fake radio link failure (RLF) to cease receiving first data from the first base station through the first receiving beam, using the first antenna module; and based on the fake RLF, perform the handover from the first base station to the second base station by releasing a connection with the first base station and establishing a connection with the second base station.

According to an embodiment, the at least one processor may be configured to identify the second antenna module corresponding to the first antenna module; based on identifying the second antenna module corresponding to the first antenna module, perform random access with the second base station through a third receiving beam formed using a third antenna module distinct from the second antenna module; and after performing the random access through the third receiving beam, perform communicate with the second base station through the second receiving beam formed using the second antenna module.

According to an embodiment, the at least one processor may be configured to identify that the second antenna module is the same as the first antenna module, and based on identifying that a value for indicating the quality of the at least one first signal received from the first base station through the second receiving beam is greater than or equal to a reference value, receive the first data and the second data; and wherein the first data may be received from the first base station through the second receiving beam, and the second data may be received from the second base station through the second receiving beam.

According to an embodiment, the at least one processor may be configured to perform random access with the second base station while the first data and the second data are received, and after the random access with the second base station is completed, perform the handover from the first base station to the second base station by ceasing the reception of the first data through the second receiving beam.

According to various embodiments, a method of an electronic device may comprise receiving a first message from a first base station which is a serving base station of the electronic device, after receiving the first message, identifying a first antenna module for forming a first receiving beam identified based on at least one first signal received from the first base station, among the plurality of antenna modules, after receiving the first message, identifying a second antenna module for forming a second receiving beam identified based on at least one second signal received from a second base station which is a neighbor base station of the first base station, among the plurality of antenna modules, and based on transmitting a second message comprising first information for indicating quality of the at least one first signal received from the first base station through the first receiving beam, and second information for indicating quality of the at least one second signal received from the second base station through the second receiving beam, performing handover from the first station to the second station.

According to an embodiment, the method may comprise identifying, based on the first message, configuration information of the second message, and transmitting, based on the configuration information of the second message, information on the first antenna module and the second antenna module through the second message.

According to an embodiment, the information on the first antenna module and the second antenna module may comprise information on whether the first antenna module and the second antenna module are the same; and whether the information on whether the first antenna module and the second antenna module are the same may be set to 1 bit.

According to an embodiment, the information on the first antenna module and the second antenna module may comprise identification information on the first antenna module and identification information on the second antenna module.

According to various embodiments, a non-transitory computer readable storage medium may store one or more programs, the one or more programs comprising instructions which, when executed by a processor of an electronic device with a plurality of antenna modules and a communication circuit, cause the electronic device to receive a first message from a first base station which is a serving base station of the electronic device; after receiving the first message, identify a first antenna module for forming a first receiving beam identified based on at least one first signal received from the first base station, among the plurality of antenna modules; after receiving the first message, identify a second antenna module for forming a second receiving beam identified based on at least one second signal received from a second base station which is a neighbor base station of the first base station, among the plurality of antenna modules; and based on transmitting a second message comprising first information for indicating quality of the at least one first signal received from the first base station through the first receiving beam, and second information for indicating quality of the at least one second signal received from the second base station through the second receiving beam, perform handover from the first station to the second station. “Based on” as used herein covers based at least on.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “Ist” and “2nd”, or “first” and “second” may be used to simply distinguish a corresponding component from another, and docs not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program #40) including one or more instructions that are stored in a storage medium (e.g., internal memory #36 or external memory #38) that is readable by a machine (e.g., the electronic device #01). For example, a processor (e.g., the processor #20) of the machine (e.g., the electronic device #01) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various example embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

Each embodiment herein may be used in combination with any other embodiment(s) described herein.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. An electronic device comprising:
a plurality of antenna modules each comprising at least one antenna;
a communication circuit connected to the plurality of antenna modules;
at least one processor comprising processing circuitry,
memory storing instructions that when executed by the at least one processor individually or collectively cause the electronic device to:
receive a first message from a first base station which is a serving base station of the electronic device,
after receiving the first message, identify a first antenna module for forming a first receiving beam identified based on at least one first signal received from the first base station, among the plurality of antenna modules,
after receiving the first message, identify a second antenna module for forming a second receiving beam identified based on at least one second signal received from a second base station which is a neighbor base station of the first base station, among the plurality of antenna modules, and
based on transmitting a second message comprising first information for indicating quality of the at least one first signal received from the first base station through the first receiving beam, and second information for indicating quality of the at least one second signal received from the second base station through the second receiving beam, perform a handover from the first station to the second station.

2. The electronic device of claim 1, wherein the instructions that when executed by the at least one processor individually or collectively cause the electronic device to:
identify, based on the first message, configuration information of the second message, and
control to transmit, based on the configuration information of the second message, information on the first antenna module and the second antenna module through the second message.

3. The electronic device of claim 2, wherein the information on the first antenna module and the second antenna module comprises information on whether the first antenna module and the second antenna module are the same, and
wherein the information on whether the first antenna module and the second antenna module are the same is set to 1 bit.

4. The electronic device of claim 2, wherein the information on the first antenna module and the second antenna module comprises identification information on the first antenna module and identification information on the second antenna module.

5. The electronic device of claim 1, wherein the instructions that when executed by the at least one processor individually or collectively cause the electronic device to:
identify that the first information and the second information satisfy a designated condition, and
based on identifying that the first information and the second information satisfy the designated condition, transmit the second message for requesting the handover from the first base station to the second base station.

6. The electronic device of claim 5, wherein the first information comprises a reference signals received power, RSRP, value of the at least one first signal,
wherein the second information comprises a RSRP value of the at least one second signal, and
wherein the instructions that when executed by the at least one processor individually or collectively cause the electronic device to identify that the RSRP value of the at least one first signal and the RSRP value of the at least one second signal satisfy a designated condition.

7. The electronic device of claim 1, wherein the instructions that when executed by the at least one processor individually or collectively cause the electronic device to:
identify, based on activated data radio bearer, information on target quality, and
generate, based on the information on the target quality, the second message.

8. The electronic device of claim 7, wherein the instructions that when executed by the at least one processor individually or collectively cause the electronic device to:
identify that the target quality is greater than or equal to a designated quality value, and
based on identifying that the target quality is greater than or equal to the designated quality value, generate the second message.

9. The electronic device of claim 1, wherein the instructions that when executed by the at least one processor individually or collectively cause the electronic device to perform, based on dual active protocol stack, DAPS, the handover from the first base station to the second base station.

10. The electronic device of claim 1, wherein the first receiving beam is set to a receiving beam in which the quality of the at least one first signal is maximum and/or high among a plurality of receiving beams formed through the plurality of antenna modules, and
wherein the second receiving beam is set to a receiving beam in which the quality of the at least one second signal is maximum and/or high among the plurality of receiving beams formed through the plurality of antenna modules.

11. The electronic device of claim 1, wherein the instructions that when executed by the at least one processor individually or collectively cause the electronic device to receive, based on transmitting the second message, a third message from the first base station,
wherein the third message comprises configuration information on the handover from the first base station to the second base station.

12. The electronic device of claim 1, wherein the instructions that when executed by the at least one processor individually or collectively cause the electronic device to:
identify the second antenna module corresponding to the first antenna module,
based on identifying the second antenna module corresponding to the first antenna module, identify fake radio link failure, RLF, to cease receiving first data from the first base station through the first receiving beam, using the first antenna module, and
based on the fake RLF, perform the handover from the first base station to the second base station by releasing a connection with the first base station and establishing a connection with the second base station.

13. The electronic device of claim 1, wherein the instructions that when executed by the at least one processor individually or collectively cause the electronic device to:
identify the second antenna module corresponding to the first antenna module, and
based on identifying the second antenna module corresponding to the first antenna module, perform random access with the second base station through a third receiving beam formed using a third antenna module distinct from the second antenna module, and
after performing the random access through the third receiving beam, perform communicate with the second base station through the second receiving beam formed using the second antenna module.

14. A method of an electronic device, comprising:
receiving a first message from a first base station which is a serving base station of the electronic device,
after receiving the first message, identifying a first antenna module for forming a first receiving beam identified based on at least one first signal received from the first base station, wherein the first antenna module is among a plurality of antenna modules,
after receiving the first message, identifying a second antenna module for forming a second receiving beam identified based on at least one second signal received from a second base station which is a neighbor base station of the first base station, among the plurality of antenna modules, and
based on transmitting a second message comprising first information for indicating quality of the at least one first signal received from the first base station through the first receiving beam, and second information for indicating quality of the at least one second signal received from the second base station through the second receiving beam, performing a handover from the first station to the second station.

15. The method of claim 14, wherein the method further comprises:
identifying, based on the first message, configuration information of the second message, and
transmitting, based on the configuration information of the second message, information on the first antenna module and the second antenna module through the second message.

16. The method of claim 15, wherein the information on the first antenna module and the second antenna module comprises information on whether the first antenna module and the second antenna module are the same, and
wherein the information on whether the first antenna module and the second antenna module are the same is set to 1 bit.

17. The method of claim 14, wherein the method further comprises:
identifying that the first information and the second information satisfy a designated condition, and
based on identifying that the first information and the second information satisfy the designated condition, transmitting the second message for requesting the handover from the first base station to the second base station.

18. The method of claim 17, wherein the first information comprises a reference signals received power, RSRP, value of the at least one first signal,
wherein the second information comprises a RSRP value of the at least one second signal, and
wherein the at least one processor is individually and/or collectively configured to identify that the RSRP value of the at least one first signal and the RSRP value of the at least one second signal satisfy a designated condition.

19. The method of claim 14, wherein the method further comprises:
identifying, based on activated data radio bearer, information on target quality, and
generating, based on the information on the target quality, the second message.

20. A non-transitory computer readable storage medium storing one or more programs, wherein the one or more programs comprises instructions which, when executed by a processor of an electronic device with a plurality of antenna modules and a communication circuit, cause the electronic device to:
receive a first message from a first base station which is a serving base station of the electronic device,
after receiving the first message, identify a first antenna module for forming a first receiving beam identified based on at least one first signal received from the first base station, among a plurality of antenna modules,
after receiving the first message, identify a second antenna module for forming a second receiving beam identified based on at least one second signal received from a second base station which is a neighbor base station of the first base station, among the plurality of antenna modules, and
based on transmitting a second message comprising first information for indicating quality of the at least one first signal received from the first base station through the first receiving beam, and second information for indicating quality of the at least one second signal received from the second base station through the second receiving beam, perform a handover from the first station to the second station.
